(19) United States
(12) Patent Application Publication
(10) Pub. No.: US 2026/0247299 A1
(43) Pub. Date: Aug. 20, 2026

(54) INFORMATION PROCESSING DEVICE, INFORMATION PROCESSING METHOD, COMMUNICATION DEVICE, AND COMMUNICATION METHOD

(71) Applicant: Sony Group Corporation, Tokyo (JP)

(72) Inventors: Hiroto KURIKI, Kanagawa (JP); Sho FURUICHI, Tokyo (JP)

(73) Assignee: Sony Group Corporation, Tokyo (JP)

(21) Appl. No.: 19/157,550

(22) PCT Filed: Mar. 19, 2024
(86) PCT No.: PCT/JP2024/010651

§ 371 Date: Aug. 18, 2025

(30) Foreign Application Priority Data
Mar. 20, 2023 (JP) 2023-044738

(51) Int. Cl. H04W 52/28; H04W 52/24

(52) U.S. Cl. CPC H04W 52/283; H04W 52/243

(57) ABSTRACT

There is provided an information processing device that further increases opportunities for spectrum use. The information processing device includes a processing unit that acquires information of an effective service area of a first communication device operated by a first operator that has a right to preferentially use a radio wave, on the basis of allowable transmission power of the radio wave transmitted from the first communication device, and determines availability of lending of the right to a second operator that operates a second communication device, on the basis of the information of the effective service area of the first communication device and information of a desired rental area where the second operator desires to operate the second communication device.

### TECHNICAL FIELD

The present disclosure relates to an information processing device, an information processing method, a communication device, and a communication method.

### BACKGROUND ART

Hitherto, due to increase in a wireless environment in which various wireless systems are mixed and an enrichment of content provided wirelessly, a problem of exhaustion of radio resources (spectrum) that can be allocated to the wireless systems has emerged. Accordingly, as a means for extracting necessary radio resources, “dynamic spectrum sharing (dynamic spectrum access (DSA))” using temporal and spatial vacancies (white spaces) in a frequency band allocated to a specific wireless system has rapidly attracted attention.

In the United States, a mechanism of a DSA called a citizens broadband radio service (CBRS) is introduced in the 3550 to 3700 MHz band and is commercially deployed. According to Non-Patent Documents 6 and 11, allocation of a priority access license (PAL) channel in the CBRS is subject to a spectrum auction for each of a country and a channel of 10 MHz. The winning communication operator can freely use the channel as a PAL in the County for a certain period of time. Furthermore, according to Non-Patent Document 5 (47 C.F.R Part 96), a communication operator that has won a PAL channel in a spectrum auction can also lend its use rights to other operators (PAL Leasing). According to Non-Patent Document 5, a spectrum access system (SAS) administrator may perform an application procedure to Federal Communications Commitments (FCC) in PAL Leasing on behalf of others.

### CITATION LIST

### Patent Document

Patent Document 1: WO 2021/085132 A1

### Non-Patent Document

Non-Patent Document 1: WINNF-TS-0112-V1. 9.1 “Requirements for Commercial Operation in the U.S. 3550-3700 MHz Citizens Broadband Radio Service Band” [available at https://cbrs.wirelessinnovation.org/release-1-of-the-baseline-standard-specifications]
Non-Patent Document 2: WINNF-SSC-0008-V1.3.0, “Spectrum Sharing Committee Policy and Procedure Coordinated Periodic Activities Policy”
Non-Patent Document 3: WINNF-TS-0061-V1.5.1 Test and Certification for Citizens Broadband Radio Service (CBRS); Conformance and Performance Test Technical Specification; SAS as Unit Under Test (UUT) [available at https://cbrs.wirelessinnovation.org/release-1-of-the-baseline-standard-specifications]
Non-Patent Document 4: WINNF-TS-0016-V1.2.4 Signaling Protocols and Procedures for Citizens Broadband Radio Service (CBRS): Spectrum Access System (SAS)—Citizens Broadband Radio Service Device (CBSD) Interface Technical Specification [available at https://cbrs.wirelessinnovation.org/release-1-of-the-baseline-standard-specifications]
Non-Patent Document 5: Electronic Code of Federal Regulations, Title 47, Chapter I, Subchapter D, Part 96 [available at https://ecfr.federalregister.gov/current/title-47/chapter-I/subchapter-D/part-96]
Non-Patent Document 6: Auction 105:3.5 GHZ Band [available at https://www.fcc.gov/auction/105]
Non-Patent Document 7: “940660 D02 CPE-CBSD Handshake Procedures v02”, Federal Communications Commission Office of Engineering and Technology Laboratory Division, October 2019, available at https://apps.fcc.gov/oetcf/kdb/forms/FTSSearchResultPage.cfm?id=229297&switch=P
Non-Patent Document 8: ECC Report 186 Technical and operational requirements for the operation of white space devices under geo-location approach [available at https://docdb.cept.org/document/293]
Non-Patent Document 9: Implementing TV White Spaces-Ofcom [available at https://www.ofcom.org.uk/_data/assets/pdf_file/0034/68668/tvws-statement.pdf]
Non-Patent Document 10: WINNF-TS-1001 V1.4.0, “CBRS Operational and Functional Requirements (Release 2)” [available at https://cbrs.wirelessinnovation.org/enhancements-to-baseline-specifications]
Non-Patent Document 11:3.5 GHz Band Overview [available at https://www.fcc.gov/35-ghz-band-overview]

### SUMMARY OF THE INVENTION

### Problems to be Solved by the Invention

In a case where the SAS administrator performs the application procedure to the FCC in PAL Leasing on behalf, a Lessee (borrower) who intends to borrow a license (PAL) from a Lessor (lender) can submit, to the SAS administrator, information necessary for lending including an area where the license is desired to be lent, and apply for lending.

Upon receiving the license lending application from Lessee, the SAS Administrator determines whether the desired rental area is outside the service area of the CBSD of Lessor, and determines lending availability. For example, if a part of the desired rental area of Lessee is within the service area of Lessor, the lending may be rejected. In the case of CBRS, a service area of the CBSD of Lessor is typically a PAL Protection Area (PPA) of the CBSD of the Lessor. The PPA is calculated, for example, according to the method described in Non-Patent Document 1 on the basis of maximum equivalent isotropic radiated power (EIRP) capability when CBSD is registered in SAS.

On the other hand, with respect to a CBSD (PAL CBSD) that provides a service on the basis of PAL of the Lessor, SAS determines transmission power allowed for the PAL CBSD by performing an iterative allocation process (IAP) in a Cooperative Periodic Activities among SASs (CPAS) for the purpose of protecting a primary system (Incumbent) that is a system to be protected in a higher-tier and protecting PPAs of other PAL CBSDs. The SAS issues a grant (Grant) allowing spectrum use (service provision) with the determined allowable transmission power to the PAL CBSD. The Grant issued to the PAL CBSD is referred to as a PAL Grant.

Transmission power allowed for the PAL Grant is usually a value lower than the EIRP Capability. In this case, the effective service area of the PAL Grant is smaller than the PPA calculated on the basis of the EIRP. Therefore, a range of a difference between the PPA and the effective service area can be originally lent to Lessee. However, in lending availability determination based on the PPA, even if the desired rental area does not overlap a range permitted by the PAL Grant, if the area overlaps the range of the difference described above, the lending is rejected. Therefore, it cannot be said that the lending opportunities are fully used, and opportunities for spectrum use are reduced.

In view of the above problems, an object of the present disclosure is to further increase opportunities for spectrum use.

### Solutions to Problems

An information processing device according to the present disclosure includes a processing unit that acquires information of an effective service area of a first communication device operated by a first operator that has a right to preferentially use a radio wave, on the basis of allowable transmission power of the radio wave transmitted from the first communication device, and determines availability of lending of the right to a second operator that operates a second communication device, on the basis of the information of the effective service area of the first communication device and information of a desired rental area where the second operator desires to operate the second communication device.

### BRIEF DESCRIPTION OF DRAWINGS

FIG. 1 is a diagram illustrating a system model in an embodiment of the present disclosure.

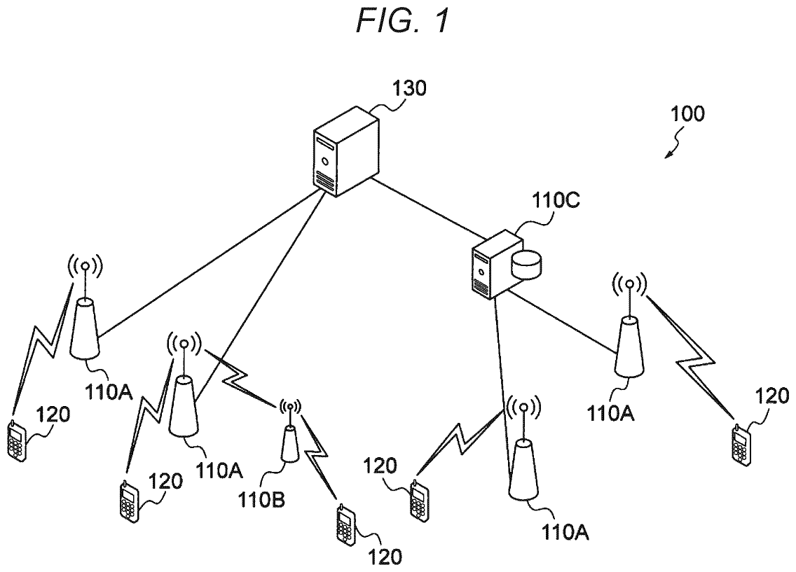

FIG. 2 is a diagram illustrating a network configuration to which autonomous decision-making can be applied.

FIG. 3 is a diagram illustrating a network configuration to which centralized decision-making can be applied.

FIG. 4 is a diagram illustrating a network configuration in a case where both centralized decision-making and distributed decision-making are applied.

FIG. 5 is a diagram for describing a three-tier structure in CBRS.

FIG. 6 is a diagram for describing a flow of signaling between terminals.

FIG. 7 is a diagram illustrating an example of a flow according to lending availability determination for Lessee.

FIG. 8 is a diagram illustrating an example of a service area SA1 of CBSD_A of Lessor A and a desired rental area SB of Lessee B.

FIG. 9 is a diagram illustrating another example of the service area SA1 of CBSD_A of Lessor A and the desired rental area SB of Lessee B.

FIG. 10 is a diagram illustrating a relationship among PPA_A of CBSD_A, an effective service area SA2 of CBSD_A, and a desired rental area SB of Lessee B.

FIG. 11 is a block diagram of a communication system according to the present embodiment.

FIG. 12 is a diagram illustrating a system configuration example in a case where a Leasing Manager is provided as an information processing device independent of SAS.

FIG. 13 is a diagram illustrating an example of a flow of lending availability determination according to the present embodiment.

FIG. 14 is a diagram illustrating another example of a flow of the lending availability determination according to the present embodiment.

FIG. 15 is a diagram illustrating an example in which CBSD_B of Lessee B is located outside the effective service area SA2 of CBSD_A and within PPA_A of CBSD_A.

FIG. 16 is a diagram illustrating an example of a flow of processing involving re-execution of the lending availability determination according to the present embodiment.

FIG. 17 is a diagram illustrating another example of a flow of processing involving re-execution of the lending availability determination according to the present embodiment.

FIG. 18 is a diagram illustrating an example in which an area Z obtained by excluding an area overlapping with a desired rental area SB of Lessee B from PPA_A of CBSD_A is set as an effective service area of CBSD_A.

FIG. 19 is a diagram illustrating an example in which an indoor service area SA3 is separately calculated in an outdoor service area SA4 of CBSD_A.

### MODE FOR CARRYING OUT THE INVENTION

Hereinafter, embodiments of the present disclosure will be described in detail with reference to the drawings. In one or more embodiments described in the present disclosure, elements included in each of the embodiments can be combined with each other, and the combined resultant also forms part of the embodiments described in the present disclosure.

### 1. Assumed Representative Scenario

### <1.1 System Model>

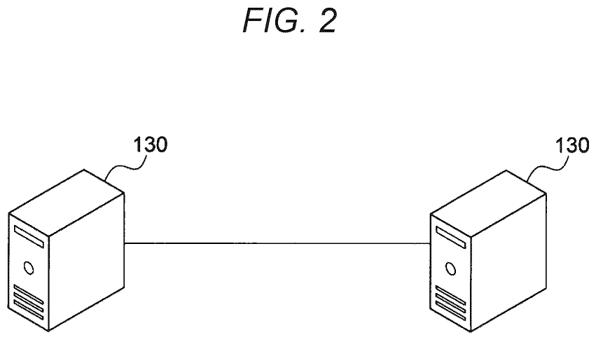

FIG. 2 illustrates a system model in an embodiment of the present invention. As illustrated in FIG. 2, this system model is represented by a communication network 100 including wireless communication, and typically includes the following entities.
Communication device 110
Terminal 120
Communication control device 130

Furthermore, this system model includes at least a primary system and a secondary system using the communication network 100. The primary system and the secondary system are configured by the communication device 110 or the communication device 110 and the terminal 120. Various communication systems can be treated as the primary system or the secondary system, but in the present embodiment, it is assumed that the primary system and the secondary system each use some or all of a frequency band. Note that the respective frequency bands allocated to the primary system and the secondary system may partially or entirely overlap or may not overlap at all. That is, this system model will be described as a model of a wireless communication system related to dynamic spectrum sharing (dynamic spectrum access (DSA)). Note that this system model is not limited to systems related to dynamic spectrum sharing.

Typically, the communication device 110 is a wireless device that provides a wireless communication service to the terminal 120, such as a wireless base station (Base Station, Node B, eNB, gNB, or the like) or a wireless access point. That is, the communication device 110 provides the wireless communication service to enable wireless communication of the terminal 120. Furthermore, the communication device 1 may be a wireless relay device or an optical extension device called a Remote Radio Head (RRH). In the following description, unless otherwise noted, the communication device 110 will be described as an entity constituting the secondary system.

The coverage (communication region) provided by the communication device 110 is allowed to have various sizes from a large size such as a macro cell to a small size such as a pico cell. Like a distributed antenna system (DAS), a plurality of the communication devices 110 may form one cell. Furthermore, in a case where the communication device 110 has a capability of beamforming, a cell or a service area may be formed for each beam.

In the present disclosure, it is assumed that there are two different types of communication devices 110.

In the present disclosure, the communication device 110 that can access the communication control device 130 without using a wireless path that requires permission of the communication control device 130 is referred to as a “communication device 110A”. Specifically, for example, the communication device 110 capable of a wired Internet connection can be regarded as the “communication device 110A”. Furthermore, for example, even in a wireless relay device that does not have a wired Internet connection function, if a wireless backhaul link using a spectrum that does not require permission of the communication control device 130 is constructed with another communication device 110A, such a wireless relay device may also be regarded as the “communication device 110A”.

In the present disclosure, the communication device 110 that cannot access the communication control device 130 without a wireless path that requires permission of the communication control device 130 is referred to as a “communication device 110B”. For example, a wireless relay device that needs to construct a backhaul link using a spectrum that requires permission of the communication control device 130 can be regarded as the “communication device 110B”. Furthermore, for example, a device such as a smartphone having a wireless network provision function represented by tethering and using a spectrum that requires permission of the communication control device 130 in both the backhaul link and the access link may be treated as the “communication device 110B”.

The communication device 110 is not necessarily fixedly installed. For example, the communication device 110 may be installed in a mobile object such as an automobile. Furthermore, the communication device 110 does not necessarily need to exist on the ground. For example, the communication device 110 may be included in an object existing in the air or space, such as an aircraft, a drone, a helicopter, a high altitude platform station (HAPS), a balloon, or a satellite. Furthermore, for example, the communication device 110 may be included in an object existing on the sea or under the sea, such as a ship or a submarine. Typically, such a mobile communication device 110 corresponds to the communication device 110B, and performs wireless communication with the communication device 110A to secure an access path to the communication control device 130. As a matter of course, even the mobile communication device 110 can be treated as the communication device 110A as long as the spectrum used in the wireless communication with the communication device 110A is not managed by the communication control device 130.

In the present disclosure, unless otherwise specified, the description “communication device 110” includes both meanings of the communication device 110A and the communication device 110B, and may be replaced with either one.

The communication device 110 can be used, operated, or managed by various operators. For example, a mobile network operator (MNO), a mobile virtual network operator (MVNO), a mobile network enabler (MNE), a mobile virtual network enabler (MVNE), a shared facility operator, a neutral host network (NHN) operator, a broadcaster, an enterprise, an educational institution (educational institutions, respective boards of education of local governments, or the like), a real estate (building, apartment, or the like) administrator, an individual, and the like can be assumed as operators related to the communication device 110. Note that the operator related to the communication device 110 is not particularly limited. Furthermore, the communication device 110A may be a shared facility used by a plurality of operators. Furthermore, different operators may perform installation, use, and management of the facilities.

The communication device 110 operated by the operator is typically connected to the Internet via a core network. Furthermore, operation, management, and maintenance are performed by a function called Operation, Administration & Maintenance (OA&M). Furthermore, for example, as illustrated in FIG. 2, there may be an intermediate device (network manager) 110C that centrally controls the communication devices 110 in the network. Note that there may be cases where the intermediate device is the communication device 110 or cases where the intermediate device is the communication control device 130.

The terminal 120 (User Equipment, User Terminal, User Station, Mobile Terminal, Mobile Station, or the like) is a device that performs wireless communication using a wireless communication service provided by the communication device 110. Typically, communication equipment such as a smartphone corresponds to the terminal 120. Note that a device having a wireless communication function can correspond to the terminal 120. For example, equipment such as a business camera having a wireless communication function can also correspond to the terminal 120 even if the wireless communication is not a main application. Furthermore, communication equipment that transmits data to the terminal 120, such as a wireless station for broadcasting business (field pickup unit (FPU)) that transmits an image for television broadcasting or the like from an outside (site) of a broadcast station to the broadcast station in order to broadcast sports or the like, also corresponds to the terminal 120. Furthermore, the terminal 120 is not necessarily used by a person. For example, like what is called machine type communication (MTC), equipment such as a factory machine or a sensor installed in a building may be network-connected to operate as the terminal 120. Furthermore, a device called customer premises equipment (CPE) provided to ensure connection to the Internet may behave as the terminal 120.

Furthermore, as represented by device-to-device (D2D) and vehicle-to-everything (V2X), the terminal 120 may include a relay communication function.

Furthermore, similarly to the communication device 110, the terminal 120 need not be fixedly installed or exist on the ground. For example, an object existing in the air or space, such as an aircraft, a drone, a helicopter, a satellite, or the like, may operate as the terminal 120. Furthermore, for example, an object existing on the sea or under the sea, such as a ship or a submarine, may operate as the terminal 120.

In the present disclosure, unless otherwise noted, the terminal 120 corresponds to an entity where a wireless link using a spectrum that requires permission of the communication control device 130 terminates. However, depending on a function included in the terminal 120 or an applied network topology, the terminal 120 can perform an operation equivalent to that of the communication device 110. In other words, depending on the network topology, there may be cases where a device that can correspond to the communication device 110 such as a wireless access point corresponds to the terminal 120, or cases where a device that can correspond to the terminal 120 such as a smartphone corresponds to the communication device 110.

The communication control device 130 is typically a device that determines, permits, gives an instruction on, and/or manages communication parameters of the communication device 110. For example, database servers called TV white space database (TVWSDB), geolocation database (GLDB), spectrum access system (SAS), and automated frequency coordination (AFC) correspond to the communication control device 130. In other words, a database server having an authority and a role such as authentication and supervision of radio wave use related to secondary use of a spectrum can be regarded as the communication control device 130.

The communication control device 130 also corresponds to a database server having a role different from the above-described role. For example, a control device that performs radio wave interference control between communication devices represented by a Spectrum Manager (SM) in EN 303 387 of the European Telecommunications Standards Institute (ETSI), a Coexistence Manager (CM) in the Institute of Electrical and Electronics Engineers (IEEE) 802.19.1-2018, a Coexistence Manager (CxM) in CBRSA-TS-2001, or the like also corresponds to the communication control device 130. Furthermore, for example, a registered location secure server (RLSS) defined in IEEE 802.11-2016 also corresponds to the communication control device 130. That is, not limited to these examples, an entity responsible for determination, use permission, instruction, management, and the like of the communication parameters of the communication device 110 may be referred to as the communication control device 130. Basically, the control target of the communication control device 130 is the communication device 110, but the communication control device 130 may control the terminal 120 subordinate to the communication device 110.

The communication control device 130 also corresponds to a combination of a plurality of database servers having different roles. For example, CBRS Alliance SAS (CSAS) which is a combination of SAS and CxM illustrated in CBRSA-TS-2001 can also be regarded as the communication control device 130.

The communication control device 130 can also be implemented by software having a function equivalent to that of the database server installed on one database server. For example, a SAS having a function or software equivalent to CxM can also be regarded as the communication control device 130.

There may be a plurality of communication control devices 130 having similar roles. In a case where there is the plurality of communication control devices 130 having similar roles, at least one of at least the following three types of decision-making topologies can be applied to the communication control device 130.
Autonomous decision-making
Centralized decision-making
Distributed decision-making

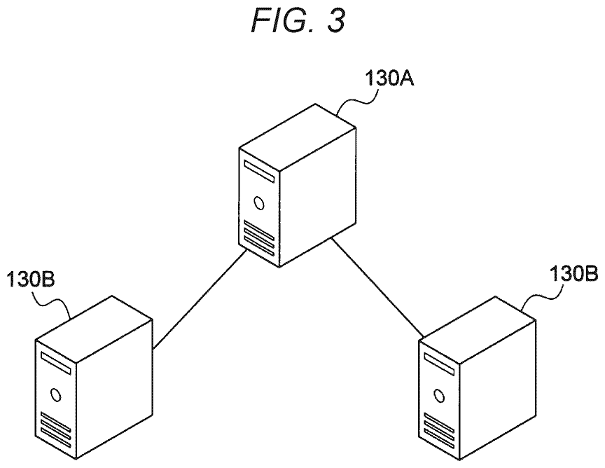

The autonomous decision-making is a decision-making topology in which an entity (the decision-making entity, here the communication control device 130) that makes a decision makes a decision independently from another decision-making entity. The communication control device 130 independently calculates necessary spectrum allocation and interference control. For example, in a case where a plurality of communication control devices 130 is arranged in a distributed manner as illustrated in FIG. 3, the autonomous decision-making can be applied.

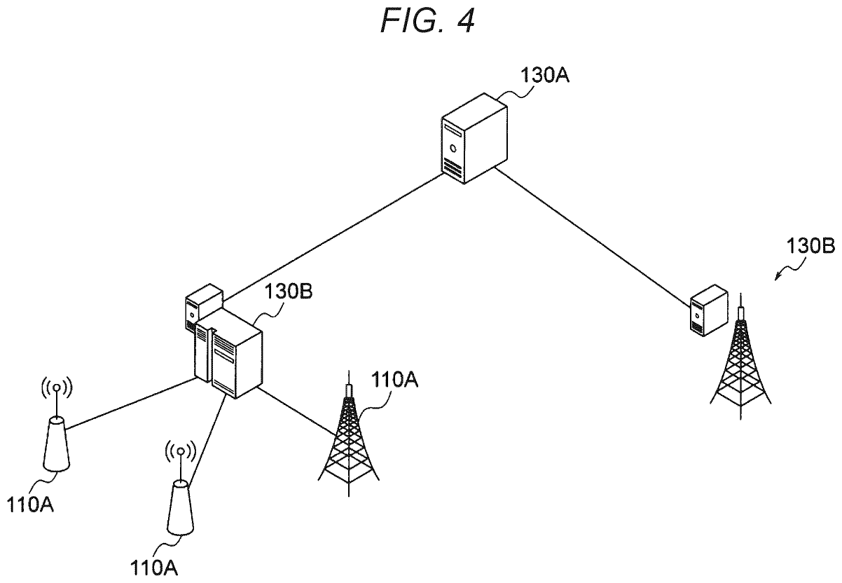

The centralized decision-making is a decision-making topology in which a decision-making entity delegates decision-making to another decision-making entity. In a case where the centralized decision-making is performed, for example, a model as illustrated in FIG. 4 can be assumed. FIG. 4 illustrates a model (what is called master-slave type) in which one communication control device 130 performs centralized control of the plurality of communication control devices 130. In the model of FIG. 4, the communication control device 130A, which is the master, can control the communication control devices 130B, which are a plurality of slaves, to intensively make decisions.

The distributed decision-making is a decision-making topology in which a decision-making entity makes a decision in cooperation with another decision-making entity. For example, while a plurality of communication control devices 130 independently makes a decision as in the autonomous decision-making in FIG. 3, mutual adjustment of decision-making results, negotiation, and the like performed by each communication control device 130 after making a decision may correspond to “distributed decision-making”. Furthermore, for example, in the centralized decision-making in FIG. 4, for the purpose of load balancing or the like, performing dynamic delegation of decision-making authority to each slave communication control device 130B, deletion thereof, or the like by the master communication control device 130A can also be regarded as “distributed decision-making”.

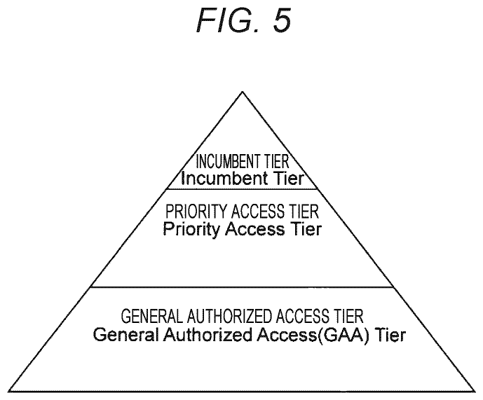

There may be cases where both the centralized decision-making and the distributed decision-making are applied. In FIG. 5, the slave communication control device 130B operates as an intermediate device that bundles the plurality of communication devices 110. It is not necessary for the master communication control device 130A to control the communication devices 110 bundled by the slave communication control device 130B, that is, the secondary system configured by the slave communication control device 130B. As described above, as a modification, implementation as illustrated in FIG. 5 is also possible.

The communication control device 130 may also acquire necessary information from entities other than the communication device 110 and the terminal 120 of the communication network 100 for its role. Specifically, for example, information necessary for protecting the primary system can be acquired from a database (regulatory database) managed or operated by a radio administration agency (national regulatory authority (NRA)) of a country or a region. Examples of the regulatory database include the Universal Licensing System (ULS) operated by the Federal Communications Commissions (FCC), and the like. Examples of information necessary for protecting the primary system include, for example, position information of the primary system, communication parameters of the primary system, an out-of-band emission (OOBE) limit, an adjacent channel leakage ratio (ACLR), adjacent channel selectivity, a fading margin, a protection ratio (PR), and the like. In a region where a fixed numerical value, an acquisition method, a derivation method, and the like are defined by a law or the like in order to protect the primary system, it is desirable to use information defined by the law as information necessary for protecting the primary system.

Furthermore, a database that records the communication device 110 and the terminal 120 that have been subjected to conformity authentication, such as an equipment authorization system (EAS) managed by the Office of Engineering and Technology (OET) of the FCC, also corresponds to the regulatory database. From such a regulatory database, it is possible to acquire information regarding an operable spectrum of the communication device 110 or the terminal 120, information regarding maximum equivalent isotropic radiated power (EIRP), and the like. Naturally, the communication control device 130 may use these pieces of information for protecting the primary system.

Furthermore, it can also be assumed that the communication control device 130 acquires radio wave sensing information from a radio wave sensing system installed and operated for the purpose of radio wave detection in the primary system. As a specific example, in citizens broadband radio service (CBRS) in the United States, the communication control device 130 acquires radio wave detection information of a ship radar as a primary system from a radio wave sensing system called an environmental sensing capability (ESC). Furthermore, in a case where the communication device 110 and the terminal 120 have a sensing function, the communication control device 130 may acquire radio wave detection information of the primary system from these.

Furthermore, it can also be assumed that the communication control device 130 acquires activity information of the primary system from a portal system that manages the activity information of the primary system. As a specific example, in citizens broadband radio service (CBRS) in the United States, the communication control device 130 acquires the activity information of the primary system from a calendar-type system called Informing Incumbent Portal. Protection of the primary system is achieved by enabling a protection area called Dynamic Protection Area (DPA) on the basis of the acquired activity information. Protection of the primary system is also implemented by an equivalent system called Informing Incumbent Capability (IIC) in a similar manner.

The interface between the respective entities constituting this system model may be wired or wireless. For example, not only a wired line but also a wireless interface that does not depend on spectrum sharing may be used as an interface between the communication control device 130 and the communication device 110. Examples of the wireless interface that does not depend on spectrum sharing include, for example, a wireless communication line provided by a mobile network operator via a licensed band, Wi-Fi communication using an existing license-exempt band, and the like.

### <1.2 Terms Related to Spectrum and Sharing>

As described above, the present embodiment will be described assuming a dynamic spectrum sharing (Dynamic Spectrum Access) environment. As a representative example of the dynamic spectrum sharing, a mechanism defined by the CBRS in the United States (that is, a mechanism defined in Part 96 Citizens Broadband Radio Service of the FCC Rules of the United States) will be described.

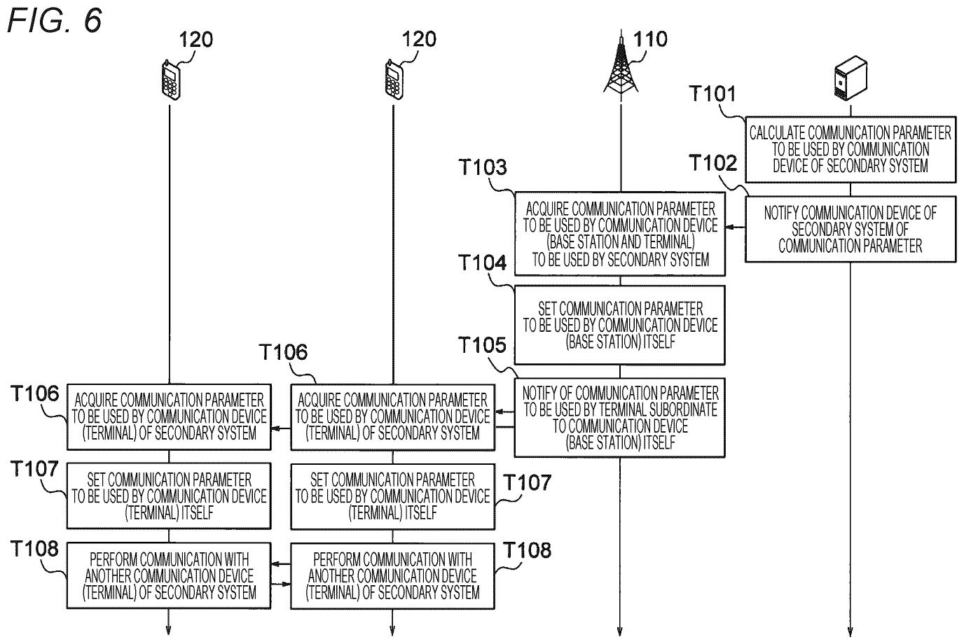

In the CBRS, as illustrated in FIG. 6, each of users in the frequency band is classified into one of three groups. This group is referred to as a tier. The three groups are referred to as an Incumbent Tier, a Priority Access Tier, and a General Authorized Access (GAA) Tier, respectively.

The Incumbent Tier is a group including existing users who conventionally use frequency bands. The existing user is also generally referred to as a primary user. In the CBRS, the Department of Defense (DOD), fixed satellite operators, and new rule excepted radio broadband licensees (Grandfathered Wireless Broadband Licensees (GWBL)) in the United States are defined as existing users. The Incumbent Tier is not required to avoid interference to the Priority Access Tier and the GAA Tier with lower priorities or to suppress use of the frequency band. Furthermore, the Incumbent Tier is protected from interference by the Priority Access Tier and the GAA Tier. That is, users of the Incumbent Tier can use the frequency band without considering the existence of other groups.

The Priority Access Tier is a group including users who use the frequency band on the basis of the above-described priority access license (PAL). A user of the Priority Access Tier is also generally referred to as a secondary user. When the frequency band is used, the Priority Access Tier is required to avoid interference and to suppress use of the frequency band for the Incumbent Tier having a higher priority than the Priority Access Tier. On the other hand, neither avoiding interference nor suppressing use of the frequency band is required for the GAA Tier having a lower priority than the priority access tier. Furthermore, the Priority Access Tier is not protected from interference by the Incumbent Tier with a higher priority, but is protected from interference by the GAA Tier with a lower priority.

The GAA Tier is a group including frequency band users that do not belong to the Incumbent Tier and the Priority Access Tier. Similarly to the Priority Access Tier, in general, a user of the GAA Tier is also referred to as a secondary user. However, since the priority of shared use is lower than that of the Priority Access Tier, it is also referred to as a low priority secondary user. When the frequency band is used, the GAA Tier is required to avoid interference and suppress use of the frequency band for the Incumbent Tier and the Priority Access Tier having higher priorities. Furthermore, the GAA Tier is not protected from interference by the Incumbent Tier and Priority Access Tier with higher priority.

Although the CBRS mechanism has been described above as a representative example of the dynamic spectrum sharing, the present embodiment is not limited to the definition of CBRS. For example, as illustrated in FIG. 6, the CBRS generally employs a three-tier structure, but a two-tier structure may be employed in the present embodiment. Representative examples of the two-tier structure include Authorized Shared Access (ASA), Licensed Shared Access (LSA), evolved LSAs (eLSAs), TV band white space (TVWS), US 6 GHz band sharing, and the like. In the ASA, the LSA, and the eLSA, there is no GAA Tier, and a structure equivalent to a combination of the Incumbent Tier and the Priority Access Tier is employed. Furthermore, in the TVWS and the US 6 GHz band sharing, there is no Priority Access Tier, and a structure equivalent to a combination of the Incumbent Tier and the GAA Tier is employed. Furthermore, there may be four or more tiers. Specifically, for example, four or more tiers may be generated by providing a plurality of intermediate layers corresponding to the Priority Access Tiers and giving different priorities to the respective intermediate layers, and the like. Furthermore, for example, the tiers may be increased by similarly dividing the GAA Tier and giving priorities, and the like. That is, each group may be divided.

Furthermore, the primary system of the present embodiment is not limited to the definition of CBRS. For example, as an example of the primary system, a wireless system such as TV broadcasting, a fixed microwave line (fixed system (FS)), a meteorological radar, a radio altimeter, a wireless train control system (communications-based train control), and a radio astronomy are assumed. Furthermore, the present embodiment is not limited thereto, and any wireless system can be the primary system of the present embodiment.

Furthermore, as described above, the present embodiment is not limited to the environment of spectrum sharing. In general, in spectrum sharing or spectrum secondary use, an existing system that uses a target frequency band is referred to as a primary system, and a secondary user is referred to as a secondary system. However, in a case where the present embodiment is applied to an environment other than the spectrum sharing environment, they should be read by replacing with other terms. For example, a macrocell base station in a heterogeneous network (HetNet) may be the primary system, and a small cell base station or a relay station may be the secondary system. Furthermore, the base station may be the primary system, and a relay user equipment (Relay UE) or a Vehicle UE that implements D2D or V2X existing within its coverage may be the secondary system. The base station is not limited to a fixed type, and may be a portable type or a mobile type. In such a case, for example, the communication control device 130 of the present embodiment may be included in a core network, a base station, a relay station, a Relay UE, or the like.

Furthermore, in a case where the present embodiment is applied to an environment other than the spectrum sharing environment, the term “spectrum” in the present disclosure is replaced with another term shared by the application destination. For example, terms such as “resource”, “resource block”, “resource element”, “resource pool”, “channel”, “component carrier”, “carrier”, “subcarrier”, and “bandwidth part (BWP)”, or another term having a meaning equivalent or similar thereto are assumed to be used.

### 1. DESCRIPTION OF VARIOUS PROCEDURES ASSUMED IN PRESENT EMBODIMENT

Here, a basic procedure that can be used in the implementation of the present embodiment will be described. Note that up to <2.5> described later will be described on the assumption that the processing is mainly performed in the communication device 110A.

### <2.1 Registration Procedure>

A registration procedure is a procedure for registering information of a wireless system that intends to use the frequency band. More specifically, it is a procedure for registering device parameters related to the communication device 110 of the wireless system in the communication control device 130. Typically, the registration procedure is started by that the communication device 110 representing a wireless system that intends to use the frequency band notifies the communication control device 130 of a registration request including the device parameters. Note that, in a case where a plurality of the communication devices 110 belongs to the wireless system that intends to use the frequency band, the device parameters of each of the plurality of communication devices is included in the registration request. Furthermore, a device that transmits the registration request as a representative of the wireless system may be appropriately determined.

### <2.1.1 Details of Required Parameters>

The device parameter refers to, for example, the following information.
Information regarding a user of the communication device 110 (hereinafter described as user information)
Information unique to the communication device 110 (hereinafter described as unique information)
Information regarding a position of the communication device 110 (hereinafter described as position information)
Information regarding an antenna included in the communication device 110 (hereinafter described as antenna information)
Information regarding the wireless interface included in the communication device 110 (hereinafter described as wireless interface information)
Legal information regarding the communication device 110 (hereinafter described as legal information)
Information regarding an installer of the communication device 110 (hereinafter described as installer information)
Information regarding the group to which the communication device 110 belongs (hereinafter, group information)

The device parameter is not limited to the above. Information other than these may be treated as the device parameters. Note that the device parameters do not need to be transmitted at once, and may be transmitted in a divided manner a plurality of times. That is, a plurality of registration requests may be transmitted for one registration procedure. In this manner, one procedure or one processing in the procedure may be performed a plurality of times. This similarly applies to the procedure described below.

The user information is information related to the user of the communication device 110. For example, a user ID, an account name, a user name, a user contact address, a call sign, and the like can be assumed. The user ID and the account name may be independently generated by the user of the communication device 110 or may be issued in advance by the communication control device 130. As the call sign, it is desirable to use a call sign issued by the NRA.

The user information can be used, for example, in an application of interference resolution. As a specific example, in a spectrum use notification procedure described in <2.5> to be described later, even if the communication control device 130 makes the use stop determination on the spectrum being used by the communication device 110 and gives an instruction based on the use stop determination, there may be a case where notification of a spectrum use notification request of the spectrum is continuously provided. In this case, suspecting a failure of the communication device 110, the communication control device 130 can give a behavior check request for the communication device 110 to the user contact address included in the user information. Not limited to this example, in a case where it is determined that the communication device 110 is performing an operation against communication control performed by the communication control device 130, the communication control device 130 can make a contact using the user information.

The unique information is information that can specify the communication device 110, product information of the communication device 110, information regarding hardware or software of the communication device 110, and the like.

The information that can specify the communication device 110 can include, for example, a manufacturing number (serial number) of the communication device 110, an ID of the communication device 110, and the like. The ID of the communication device 110 may be uniquely given by the user of the communication device 110, for example.

The product information of the communication device 110 can include, for example, information regarding an authentication ID, a product model number, a manufacturer, and the like. The authentication ID is, for example, an ID given from a certificate authority in each country or region, such as an FCC ID in the United States, a CE number in Europe, and a technical standards conformity certification (technical conformity) in Japan. An ID issued by an industry association or the like on the basis of a unique authentication program may also be regarded as the authentication ID.

The unique information represented by these may be used, for example, for a permission list (allowlist) or a denial list (denylist). For example, in a case where any piece of information regarding the communication device 110 in operation is included in the denial list, the communication control device 130 can instruct the communication device 110 to stop using the spectrum in the spectrum use notification procedure described in <2.5> described later. Moreover, the communication control device 130 can take a behavior of not canceling the use stop measure until the communication device 110 is cancelled from the denial list. Furthermore, for example, the communication control device 130 can reject registration of the communication device 110 included in the denial list. Furthermore, for example, the communication control device 130 can also perform an operation that does not consider the communication device 110 corresponding to the information included in the denial list in the interference calculation of the present disclosure or that considers only the communication device 110 corresponding to the information included in the permission list in the interference calculation.

Note that, in the present disclosure, the FCC ID may be used as information regarding transmission power. For example, in an equipment authorization system (EAS) database, which is a type of regulatory database, information regarding a device for which authentication has been acquired can be acquired, and an application programming interface (API) thereof is also disclosed. For example, certified maximum EIRP information or the like can be included in the information together with the FCC ID. Since such power information is associated with the FCC ID, the FCC ID can be handled as transmission power information. Similarly, the FCC ID may be treated as equivalent to other information included in the EAS. Furthermore, not limited to the FCC ID, in a case where information associated with the authentication ID is present, the authentication ID may be treated as equivalent to the information.

The information regarding the hardware of the communication device 110 can include, for example, transmission power class information. For example, in Title 47 Code of Federal Regulations (C.F.R) Part 96 in the United States, two types of classes Category A and Category B are defined as the transmission power class information, and information regarding the hardware of the communication device 110 conforming to the definition can include information regarding which of the two types of classes it belongs to. Furthermore, in TS36.104 and TS38.104 of 3rd Generation Partnership Project (3GPP), some classes of eNodeB and gNodeB are defined, and these definitions can also be used.

The transmission power class information can be used, for example, in an application of interference calculation. The interference calculation can be performed using the maximum transmission power defined for each class as the transmission power of the communication device 110.

The information regarding the software of the communication device 110 can include, for example, version information, a build number, and the like regarding an execution program in which processing necessary for interaction with the communication control device 130 is described. Furthermore, version information, a build number, and the like of software for operating as the communication device 110 may also be included.

The position information is typically information that can specify the position of the communication device 110. For example, it is coordinate information acquired by a positioning function represented by the Global Positioning System (GPS), Beidou, the Quasi-Zenith Satellite System (QZSS), Galileo, or the Assisted Global Positioning System (A-GPS). Typically, information related to latitude, longitude, ground level or sea level, altitude, and positioning error can be included. Alternatively, for example, the position information may be position information registered in an information management device managed by the National Regulatory Authority (NRA) or its entrusted institution. Alternatively, for example, coordinates of an X axis, a Y axis, and a Z axis with a specific geographical position as an origin may be used. Furthermore, together with such coordinate information, an identifier indicating whether the communication device 110 exists outdoors or indoors can be given.

Furthermore, the position information may include positioning accuracy information (location uncertainty). For example, both or one of a horizontal plane and a vertical plane may be provided as the positioning accuracy information. For example, the positioning accuracy information (location uncertainty) can be used as a correction value when calculating a distance to any point. Furthermore, for example, the positioning accuracy information can also be used as region information in which the communication device 110 is likely to be located. In this case, it is used for processing of specifying spectrum information that can be used in the region indicated by the positioning accuracy information.

Furthermore, the position information may be information indicating a region in which the communication device 110 is located. For example, information indicating a region determined by the government, such as a postal code or an address, may be used. Furthermore, for example, the region may be indicated by a set of three or more geographic coordinates. These pieces of information indicating the region may be provided together with the coordinate information.

Furthermore, in a case where the communication device 110 is located indoors, information indicating the floor of a building where the communication device 110 is located can also be included in the position information. For example, an identifier indicating the number of floors, the ground, or the underground, or the like can be included in the position information. Furthermore, for example, information indicating a further closed space inside a building, such as a room number and a room name in the building, can be included in the position information.

Typically, the positioning function is desirably included in the communication device 110. However, there may be cases where performance of the positioning function does not satisfy the required accuracy. Furthermore, even if the performance of the positioning function satisfies the required accuracy, there may be a case where it is not always possible to acquire the position information that satisfies the required accuracy depending on an installation position of the communication device 110. Therefore, a device different from the communication device 110 may include the positioning function, and the communication device 110 may acquire information related to the position from the device. The device having the positioning function may be an available existing device, or may be provided by the installer of the communication device 110. In such a case, it is desirable that the position information measured by the installer of the communication device 110 is written in the communication device 110.

The antenna information is typically information indicating performance, a configuration, and the like of an antenna included in the communication device 110. Typically, for example, information such as an antenna installation height, a tilt angle (downtilt), a horizontal orientation (azimuth), a boresight, an antenna peak gain, and an antenna model can be included.

Furthermore, the antenna information can also include information regarding a formable beam. For example, information such as a beam width, a beam pattern, and an analog or digital beamforming capability can be included.

Furthermore, the antenna information can also include information regarding performance and configuration of multiple input multiple output (MIMO) communication. For example, information such as the number of antenna elements and the maximum number of spatial streams (or the number of MIMO layers) can be included. Furthermore, codebook information to be used, weight matrix information, and the like can also be included. The weight matrix information includes a unitary matrix, a zero-forcing (ZF) matrix, a minimum mean square error (MMSE) matrix, and the like, which are obtained by singular value decomposition (SVD), eigen value decomposition (EVD), block diagonalization (BD), and the like. Furthermore, in a case where the communication device 110 includes a function such as maximum likelihood detection (MLD) that requires nonlinear calculation, information indicating the included function may be included in the antenna information.

Furthermore, the antenna information may include a zenith of direction, departure (ZOD). The ZoD is a type of radio wave arrival angle. Note that instead of being provided in notification from the communication device 110, the ZoD may be estimated and provided in notification by another communication device 110 from radio waves radiated from the antenna of the communication device 110. In this case, the communication device 110 may be a device that operates as a base station or an access point, a device that performs D2D communication, a moving relay base station, or the like. The ZoD may be estimated by a radio wave direction of arrival estimation technology such as multiple signal classification (MUSIC) or estimation of signal propagation via rotation invariance techniques (ESPRIT). Furthermore, the ZOD can be used by the communication control device 130 as measurement information.

The wireless interface information is typically information indicating a wireless interface technology included in the communication device 110. For example, identifier information indicating a technology used in GSM, CDMA2000, UMTS, E-UTRA, E-UTRA NB-IoT, 5G NR, 5G NR NB-IoT or a further next generation cellular system can be included as the wireless interface information. Furthermore, identifier information indicating a derivative technology based on Long Term Evolution (LTE)/5G such as MulteFire, Long Term Evolution-Unlicensed (LTE-U), or NR-Unlicensed (NR-U) can be included. Furthermore, identifier information indicating a standard technology such as a metropolitan area network (MAN) such as WiMAX or WiMAX2+ or a wireless LAN of the IEEE 802.11 series can also be included. Furthermore, identifier information indicating an extended global platform (XGP) or a shared XGP (sXGP) may be used. It may be identifier information of a communications technology for local power, wide area (LPWA). Furthermore, identifier information indicating a proprietary wireless technology can also be included. Furthermore, a version number or a release number of the technical specification that defines these technologies may also be included as the wireless interface information.

Furthermore, the wireless interface information can also include frequency band information supported by the communication device 110. For example, the frequency band information can be represented by an upper limit frequency, a lower limit frequency, a center frequency, a bandwidth, a 3GPP operating band number, or a combination of at least two of these, or the like. Furthermore, one or more pieces of frequency band information can be included in the wireless interface information.

The frequency band information supported by the communication device 110 can further include information indicating capability of a band extension technology such as carrier aggregation (CA) or channel bonding. For example, combinable band information or the like can be included. Furthermore, the carrier aggregation can also include information regarding a band desired to be used as a primary component carrier (PCC) or a secondary component carrier (SCC). Furthermore, the number of component carriers (the number of CCs) that can be aggregated at the same time can be included.

The frequency band information supported by the communication device 110 may further include information indicating a combination of frequency bands supported by the dual connectivity and the multi connectivity. Furthermore, information of another communication device 110 that cooperatively provides the dual connectivity and the multi connectivity may also be provided. The communication control device 130 may perform determination of the communication control disclosed in the present embodiment in consideration of another communication device 110 having a cooperative relationship or the like in subsequent procedures.

The frequency band information supported by the communication device 110 may also include information indicating radio wave usage priority such as PAL and GAA.

Furthermore, the wireless interface information can also include modulation scheme information supported by the communication device 110. For example, as a representative example, information indicating a primary modulation scheme such as frequency shift keying (FSK), n-value phase shift keying (PSK, where n is a multiplier of two, such as two, four, eight, or the like), and n-value quadrature amplitude modulation (QAM, where n is a multiplier of four, such as four, sixteen, 64, 256, 1024) can be included. Furthermore, information indicating a secondary modulation scheme such as orthogonal frequency division multiplexing (OFDM), scalable OFDM, DFT spread OFDM (DFT-s-OFDM), generalized frequency division multiplexing (GFDM), and filter bank multi carrier (FBMC) can be included.

Furthermore, the wireless interface information can also include information regarding an error correction code. For example, capabilities of a turbo code, a low density parity check (LDPC) code, a polar code, an erasure correction code, and the like, and coding rate information to be applied can be included.

The modulation scheme information and the information regarding the error correction code can also be expressed by a modulation and coding scheme (MCS) index as another aspect.

Furthermore, the wireless interface information can also include information indicating a function specific to each wireless technical specification supported by the communication device 110. For example, as a representative example, there is transmission mode (TM) information defined in LTE. Furthermore, those having two or more modes for a specific function can be included in the wireless interface information such as TM information. Furthermore, in the technical specification, in a case where the communication device 110 supports a function that is not essential in the specification even if there are not two or more modes, information indicating the supported function can also be included.

Furthermore, the wireless interface information can also include radio access technology (RAT) information supported by the communication device 110. For example, information indicating time division multiple access (TDMA), frequency division multiple access (FDMA), orthogonal frequency division multiple access (OFDMA), power division multiple access (PDMA), code division multiple access (CDMA), sparse code multiple access (SCMA), interleave division multiple access (IDMA), spatial division multiple access (SDMA), carrier sense multiple access/collision avoidance (CSMA/CA), carrier sense multiple access/collision detection (CSMA/CD), or the like can be included. Note that the TDMA, FDMA, and OFDMA are classified into orthogonal multiple access (OMA). The PDMA, CDMA, SCMA, IDMA, and SDMA are classified into non orthogonal multiple access (NOMA). A representative example of the PDMA is a technique implemented by a combination of superposition coding (SPC) and successive interference canceller (SIC). The CSMA/CA and CSMA/CD are classified into opportunistic access.

In a case where the wireless interface information includes information indicating the opportunistic access, information indicating details of the access method may be further included. As a specific example, information indicating which of frame based equipment (FBE) and load based equipment (LBE) defined in EN 301 598 of ETSI may be included.

In a case where the wireless interface information indicates the LBE, the wireless interface information may further include LBE-specific information such as a priority class.

Furthermore, the wireless interface information can also include information regarding a duplex mode supported by the communication device 110. As a representative example, information regarding a method such as frequency division duplex (FDD), time division duplex (TDD), or full duplex (FD) can be included for example.

In a case where TDD is included as the wireless interface information, TDD frame structure information used or supported by the communication device 110 can be given. Furthermore, information related to the duplex mode may be included for each frequency band indicated by the frequency band information.

In a case where the FD is included as the wireless interface information, information regarding an interference power detection level may be included.

Furthermore, the wireless interface information can also include information regarding a transmission diversity method supported by the communication device 110. For example, space time coding (SIC) or the like may be included.

Furthermore, the wireless interface information can also include guard band information. For example, information regarding a predetermined guard band size in the wireless interface can be included. Alternatively, for example, information regarding a guard band size desired by the communication device 110 may be included.

Regardless of the aspects described above, the wireless interface information may be provided for each frequency band.

The legal information is typically information regarding regulations that the communication device 110 has to comply with and defined by the radio administration agency or an equivalent agency in each country or region, authentication information acquired by the communication device 110, or the like. Typically, the information regarding the regulations can include, for example, upper limit value information of out-of-band emission, information regarding a blocking characteristic of the receiver, and the like. Typically, the authentication information can include, for example, type approval information, legal regulation information serving as an authentication acquisition criterion, and the like. The type approval information corresponds to, for example, FCC ID in the United States, the technical standards conformity certification in Japan, and the like. The legal regulation information corresponds to, for example, FCC regulation numbers in the United States, ETSI Harmonized Standard number in Europe, and the like.

Among the legal information, regarding numerical values, those defined in the standard specification of wireless interface technology may be substituted. The standard specification of the wireless interface technology corresponds to, for example, 3GPP TS36.104, TS38.104, or the like. An adjacent channel leakage ratio (ACLR) is defined therein. Instead of the upper limit information of the out-of-band emission, the upper limit of the out-of-band emission may be derived and used using the ACLR defined in the standard specification. Furthermore, the ACLR itself may be used as necessary. Furthermore, adjacent channel selectivity (ACS) may be used instead of the blocking characteristic. Furthermore, these may be used in combination, or an adjacent channel interference ratio (ACIR) may be used. Note that, in general, the ACIR has the following relationship with the ACLR and ACS.

$$\begin{matrix}[ Math . 1 ] & \\ ACIR = {( \frac{1}{ACS} + \frac{1}{ACLR} )}^{- 1} & ( 1 )\end{matrix}$$

Note that although Expression (1) uses true value expression, Expression (1) may be expressed by logarithmic expression.

The installer information can include information capable of specifying a person who installs the communication device 110 (installer), unique information associated with the installer, and the like. Typically, the installer information can include information regarding a person who is responsible for the position information of the communication device 110, such as a certified professional installer (CPI) defined in Non-Patent Document 1. The CPI discloses certified professional installer registration ID (CPIR-ID) and CPI name. Furthermore, as unique information associated with the CPI, for example, a contact address (mailing address or contact address), an e-mail address, a telephone number, a public key identifier (PKI), and the like are disclosed. It is not limited thereto, and other information related to the installer may be included in the installer information as necessary.

The group information can include information regarding the communication device group to which the communication device 110 belongs. Specifically, for example, information related to the same or equivalent type of group as disclosed in WINNF-SSC-0010 can be included. Furthermore, for example, in a case where the communication operator manages the communication devices 110 in units of groups according to its own operation policy, information regarding the groups can be included in the group information.

The information listed so far may be estimated by the communication control device 130 from other information provided from the communication device 110 without the communication device 110 providing the information to the communication control device 130. Specifically, for example, the guard band information can be estimated from the wireless interface information. In a case where the wireless interface used by the communication device 110 is E-UTRA or 5G NR, it can be estimated on the basis of the transmission bandwidth specification of E-UTRA described in 3GPP TS36.104, the transmission bandwidth specification of 5G NR described in 3GPP TS38.104, and tables described in TS38.104 illustrated below.

### [Table 1]

Table 5.6-1 Transmission Bandwidth Configuration NRB in E-UTRA Channel Bandwidths (Cited from Table 5.6-1 of 3GPP TS36.104)

TABLE 2

| Channel bandwidth | | | | | | |
|---|---|---|---|---|---|---|
| BW_{Channel} [MHz] | 1.4 | 3 | 5 | 10 | 15 | 20 |
| Transmission | 6 | 15 | 25 | 50 | 75 | 100 |
| bandwidth | | | | | | |
| configuration N_{RB} | | | | | | |

Table 5.3.3-1: Minimum Guardband (kHz) (FR1) (Cited from Table 5.3.3-1 of 3GPP TS38.104)

TABLE 3

| SCS | 5 | 10 | 15 | 20 | 25 | 30 | 40 | 50 | 60 | 70 | 80 | 90 | 100 |
|---|---|---|---|---|---|---|---|---|---|---|---|---|---|
| (kHz) | MHz | MHz | MHz | MHz | MHz | MHz | MHz | MHz | MHz | MHz | MHz | MHz | MHz |
| 15 | 242.5 | 312.5 | 382.5 | 452.5 | 522.5 | 592.5 | 552.5 | 692.5 | N.A | N.A | N.A | N.A | N.A |
| 30 | 505 | 665 | 645 | 805 | 785 | 945 | 905 | 1045 | 825 | 965 | 925 | 885 | 845 |
| 60 | N.A | 1010 | 990 | 1330 | 1310 | 1290 | 1610 | 1570 | 1530 | 1490 | 1450 | 1410 | 1370 |

Table: 5.3.3-2: Minimum Guardband (kHz) (FR2) (Cited from

### Table: 5.3.3-2 of 3GPP TS38.104)

TABLE 4

| SCS | | | | |
|---|---|---|---|---|
| (kHz) | 50 MHz | 100 MHz | 200 MHz | 400 MHz |
| 60 | 1210 | 2450 | 4930 | N.A |
| 120 | 1900 | 2420 | 4900 | 9860 |

Table 5.3.3-3: Minimum Guardband (kHz) of SCS 240 kHz SS/PBCH Block (FR2) (Cited from Table: 5.3.3-3 of 3GPP TS38.104)

| SCS | | | |
|---|---|---|---|
| (kHz) | 100 MHz | 200 MHz | 400 MHz |
| 240 | 3800 | 7720 | 15560 |

In other words, it is sufficient that the communication control device 130 can acquire the information listed so far, and the communication device 110 is not necessarily required to provide the information to the communication control device 130. Furthermore, the intermediate device 130B (for example, a network manager) that bundles the plurality of communication devices 110 does not need to provide the information to the communication control device 130A. Providing information by the communication device 110 or the intermediate device 130B to the communication control device 130 or 130A is merely one means of information provision in the present embodiment. The information listed so far means information that can be necessary for the communication control device 130 to normally complete this procedure, and means for providing the information does not matter. For example, in WINNF-TS-0061, such a method is called multi-step registration and allowed.

Furthermore, as a matter of course, the information listed so far is selectively applicable depending on the local legal system and technical specifications.

### <2.1.1.1 Supplement of Required Parameters>

In the registration procedure, in some cases, it is assumed that the device parameters related to not only the communication device 110 but also the terminal 120 are required to be registered in the communication control device 130. In such cases, the term “communication device” in the description given in <2.1.1> may be replaced with a term “terminal” or a similar term. Furthermore, parameters specific to “terminal”, not described in <2.1.1>, may also be treated as required parameters in the registration procedure. For example, there is a user equipment (UE) category defined in 3GPP, and the like.

### <2.1.2 Details of Registration Processing>

As described above, the communication device 110) representing the wireless system that intends to use the frequency band generates a registration request including the device parameter and notifies the communication control device 130 of the registration request.

Here, in a case where the installer information is included in the device parameters, the communication device 110 may perform tamper-proof processing or the like on the registration request by using the installer information. Furthermore, a part or all of the information included in the registration request may be subjected to encryption processing. Specifically, for example, a unique public key may be shared in advance between the communication device 110 and the communication control device 130, and the communication device 110 may encrypt information using a secret key corresponding to the public key. Examples of the encryption target include security sensitive information such as position information.

Note that there may be cases where the ID and the position information of the communication device 110 are disclosed, and the communication control device 130 holds in advance the ID and the position information of the main communication device 110 existing in its coverage. In such a case, since the communication control device 130 can acquire the position information from the ID of the communication device 110 that has transmitted the registration request, the position information does not need to be included in the registration request. Furthermore, it is also conceivable that the communication control device 130 returns necessary device parameters to the communication device 110 that has transmitted the registration request, and in response to this, the communication device 110 transmits a registration request including the device parameters necessary for registration. In this manner, the information included in the registration request may be different depending on the case.

After receiving the registration request, the communication control device 130 performs registration processing of the communication device 110 and returns a registration response according to a processing result. If there is no shortage or abnormality of information necessary for registration, the communication control device 130 records the information in an internal or external storage device and provides notification of normal completion. Otherwise, notification of a registration failure is provided. In a case where the registration is normally completed, the communication control device 130 may allocate an ID to each of the communication devices 110 and provide notification of such ID information at the time of response. In a case where the registration fails, the communication device 110 may provide notification of a revised registration request again. Furthermore, the communication device 110 may change the registration request and try the registration procedure until the normal completion.

Note that the registration procedure is sometimes executed even after the registration is normally completed. Specifically, for example, the registration procedure can be re-executed in a case where the position information is changed beyond a predetermined criterion due to movement, accuracy improvement, or the like. The predetermined criterion is typically determined by the legal system in each country or region. For example, in 47 C.F.R. Part 15 in the United States, a Mode II personal/portable white space device, that is, a device using a free spectrum is required to perform registration again in a case where its position changes by 100 meters or more.

### <2.2 Available Spectrum Information Query Procedure (Available Spectrum Query Procedure)>

The available spectrum information query procedure is a procedure in which a wireless system that intends to use a frequency band inquires of the communication control device 130 for information regarding an available spectrum. Note that the available spectrum information query procedure does not necessarily need to be performed. Furthermore, the communication device 110 that makes an inquiry on behalf of the wireless system that intends to use the frequency band may be the same as or different from the communication device 110 that has generated the registration request. Typically, the communication device 110 that makes an inquiry notifies the communication control device 130 of a query request including information that can specify the communication device 110, and thereby the procedure is started.

Here, typically, the available spectrum information is information indicating a spectrum in which the communication device 110 can safely perform secondary use without giving fatal interference to the primary system.

The available spectrum information is determined, for example, on the basis of a secondary use prohibited area called an exclusion zone. Specifically, for example, in a case where the communication device 110 is installed in the secondary use prohibited area provided for the purpose of protecting the primary system using a frequency channel F1, the communication device 110 is not notified of the frequency channel F1 as an available channel.

The available spectrum information can also be determined, for example, by the degree of interference to the primary system. Specifically, for example, in a case where it is determined that fatal interference is given to the primary system even outside the secondary use prohibited area, such a frequency channel is not provided in notification as an available channel in some cases. An example of a specific calculation method is described in <2.2.2> described later.

Furthermore, as described above, there may be frequency channels that are not notified as available due to conditions other than primary system protection requirements. Specifically, for example, in order to avoid interference that may occur between the communication devices 110 in advance, there may be cases where a frequency channel being used by another communication device 110 existing in the vicinity of the communication device 110 is not notified as an available channel. In this manner, the available spectrum information set in consideration of interference with the other communication device 110 may be set as, for example, “use recommended spectrum information” and provided together with the available spectrum information. That is, the “use recommended spectrum information” is desirably a subset of the available spectrum information.

Even in a case of affecting the primary system, if the influence can be avoided by reducing the transmission power, the same spectrum as of the primary system or the communication device 110 in the vicinity may be notified as an available channel. In such a case, typically, maximum allowable transmission power information is included in the available spectrum information. The maximum allowable transmission power is typically expressed by EIRP. The maximum allowable transmission power is not necessarily limited thereto, and may be provided by, for example, a combination of conducted power and an antenna gain. Moreover, the antenna gain may be set to an allowable peak gain for each spatial direction.

### <2.2.1 Details of Required Parameters>

As the information that can specify the wireless system that intends to use the frequency band, for example, unique information registered at the time of the registration procedure, the above-described ID information, and the like can be assumed.

Furthermore, the query request can also include query requirement information. The query requirement information can include, for example, information indicating a frequency band for which it is desired to know whether or not it is available. Furthermore, for example, the transmission power information can be included. The communication device 110 that makes an inquiry can include the transmission power information, for example, in a case where it is desired to know only spectrum information in which it is likely that desired transmission power can be used. The query requirement information does not necessarily need to be included in the query request.

The information indicating the frequency band may also include information indicating a format of the available spectrum information. In the IEEE 802.11 standard, a channel number is defined for each band. For example, a flag for requesting availability of a channel defined in such wireless interface technical specifications may be included. As another form, a flag for requesting availability of a unit spectrum range instead of the defined channel may be included. In a case where the unit spectrum is 1 MHz, the available spectrum information is requested for each spectrum range of 1 MHz. In a case where this flag is used, the desired unit spectrum information may be enclosed in the flag.

Furthermore, the query request can also include a measurement report. The measurement report includes results of measurement performed by the communication device 110 and/or the terminal 120. Some or all of the measurement results may be represented by raw data or may be represented by processed data. For example, standardized metrics represented by reference signal received power (RSRP), reference signal strength indicator (RSSI), and reference signal received quality (RSRQ) can be used for measurement.

### <2.2.2 Details of Available Spectrum Evaluation Processing>

After receiving the query request, the available spectrum is evaluated on the basis of the query requirement information. For example, as described above, the available spectrum can be evaluated in consideration of existence of the primary system, the secondary use prohibited area thereof, and the communication device 110 in the vicinity.

The communication control device may derive the secondary use prohibited area. For example, in a case where the maximum transmission power P_{MaxTx (dBm)} and the minimum transmission power P_{MinTx (dBm)} are defined, it is possible to calculate the range of the separation distance between the primary system and the secondary system from the following expression and determine the secondary use prohibited area.

$$[ Math . 2 ]$$

$${{PL}^{- 1} ( {P}_{MaxTx ( dBm )} - {I}_{Th ( dBm )} )}_{( dB )} \leq d < {{PL}^{- 1} ( {P}_{MinTx ( dBm )} - {I}_{Th ( dBm )} )}_{( dB )}$$

I_{Th (dBm)} is allowable interference power (a limit value of allowable interference power), d is a distance between a predetermined reference point and the communication device 110, and PL( )_{(dB)} is a function of a propagation loss. Therefore, the spectrum availability can be determined according to the positional relationship between the primary system and the communication device 110. Furthermore, in a case where transmission power information or power range information desired to be used by the communication device 110 is supplied in a request, the spectrum availability can be determined by calculating PL⁻¹(P_{Tx (dBm)}−I_{Th (dBm)}) and performing a comparison with the above-described range expression.

The maximum allowable transmission power information may be derived. Typically, the maximum allowable transmission power information is calculated by using allowable interference power information in the primary system or a protection zone thereof, position information of the reference point for calculating an interference power level suffered by the primary system, registration information of the communication device 110, and a propagation loss estimation model. Specifically, as an example, it is calculated by the following mathematical expression.

$$\begin{matrix}[ Math . 3 ] & \\ {P}_{MaxTx ( dBm )} = {I}_{Th ( dBm )} + {PL ( d )}_{( dB )} & ( 2 )\end{matrix}$$

In Expression (2), the antenna gain in a transceiver is not included, but the antenna gain in the transceiver may be included according to the maximum allowable transmission power expression method (EIRP, conducted power, and the like) or the reception power reference point (antenna input point, antenna output point, and the like). Furthermore, a safety margin or the like for compensating for variation due to fading may be included. Furthermore, a feeder loss may be considered as necessary. Furthermore, it is possible to similarly perform calculation for an adjacent channel by adding the adjacent channel leakage ratio (ACRL) or an out-of-band emission maximum value.

Furthermore, Expression (2) is described on the basis of the assumption that the single communication device 110 is an interference source (single station interference). For example, in a case where it is necessary to consider aggregated interference from a plurality of communication devices 110 at the same time, a correction value may be added. Specifically, for example, the correction value can be determined on the basis of three types (fixed/predetermined, flexible, flexible minimized) of interference margin distribution methods disclosed in Non-Patent Document 8 (ECC Report 186).

Note that the allowable interference power information itself is not necessarily directly available as in Expression (2). For example, in a case where a required signal power-to-interference power ratio (SIR) of the primary system, a signal to interference plus noise ratio (SINR), and the like are available, they may be converted into allowable interference power and used. Note that such conversion processing is not limited to this processing, and may be applied to processing of other procedures.

Note that Expression 2 is expressed using logarithms, but as a matter of course, may be used by being converted into antilogarithms at the time of implementation. Furthermore, all parameters in logarithmic notation described in the present disclosure may be used by being appropriately converted into antilogarithms.

Furthermore, in a case where the above-described transmission power information is included in the query requirement information, the available spectrum can be evaluated by a method different from the above-described method. Specifically, for example, in a case where it is assumed that desired transmission power indicated by transmission power information is used, when an estimated interference quantity is less than allowable interference power in the primary system or a protection zone thereof, it is determined that the frequency channel is available, and the communication device 110 is notified of the frequency channel.

Furthermore, for example, in a case where an area or a space in which the communication device 110 can use the frequency band is determined in advance similarly to an area of a radio environment map (REM), the available spectrum information may be simply derived on the basis of only coordinates (coordinates or latitude, longitude, and ground level of the X axis, the Y axis, and the Z axis of the communication device 110) included in the position information of the communication device 110. Furthermore, for example, even in a case where a lookup table that associates coordinates of a position of the communication device 110 with available spectrum information is prepared, the available spectrum information described above may be derived on the basis of only the position information of the communication device 110. As described above, there are various methods for the method of determining the available spectrum, and it is not limited to the example of the present disclosure.

Furthermore, in a case where the communication control device 130 acquires information regarding capability of a band extension technology such as carrier aggregation (CA) or channel bonding as the frequency band information supported by the communication device 110, the communication control device 130 may include an available combination, a recommended combination, or the like thereof in the available spectrum information.

Furthermore, in a case where the communication control device 130 acquires information regarding a combination of frequency bands supported by the dual connectivity and the multi connectivity as the frequency band information supported by the communication device 110, the communication control device 130 may include information such as an available spectrum and a recommended spectrum in the available spectrum information for the dual connectivity and the multi connectivity.

Furthermore, in a case of providing the available spectrum information for the band extension technology as described above, when the imbalance of the maximum allowable transmission power occurs between the plurality of frequency channels, the available spectrum information may be provided after adjusting the maximum allowable transmission power of each frequency channel. For example, from a perspective of primary system protection, the maximum allowable transmission power of each frequency channel may be aligned with the maximum allowable transmission power of a frequency channel having a low maximum allowable power flux density (power spectral density (PSD)).

The evaluation of the available spectrum does not necessarily need to be performed after the query request is received. For example, after normal completion of the above-described registration procedure, the communication control device 130 may independently perform the procedure without a query request. In such a case, an REM, a lookup table, or an information table similar to those described above as an example may be created.

Furthermore, the radio wave usage priority such as PAL or GAA may also be evaluated. For example, in a case where the registered device parameter or the query requirement includes information regarding the priority of radio wave use, it may be determined whether spectrum use is possible on the basis of the priority, and the notification may be made. Furthermore, for example, as disclosed in Non-Patent Document 1, in a case where information (in Non-Patent Document 1, it is referred to as a cluster list) regarding the communication device 110 that performs high priority use (for example, PAL) from the user is registered in the communication control device 130 in advance, evaluation may be performed on the basis of the information.

After the evaluation of the available spectrum is completed, the communication control device 130 notifies the communication device 110 of the evaluation result.

The communication device 110 may select a desired communication parameter by using the evaluation result received from the communication control device 130. In a case where a spectrum grant procedure (to be described later) is not employed, the communication device 110 may start radio wave transmission using the selected desired communication parameter as a communication parameter.

### <2.3 Spectrum Grant Procedure>

The spectrum grant procedure is a procedure for the wireless system that intends to use the frequency band to receive the secondary use permission of the spectrum from the communication control device 130. The communication device 110 that performs the spectrum grant procedure as a representative of the wireless system may be the same as or different from the communication device 110 that has performed the procedures so far. Typically, the communication device 110 notifies the communication control device 130 of a spectrum grant request including information that can specify the communication device 110, thereby starting the procedure. Note that, as described above, the available spectrum information query procedure is not essential. Therefore, the spectrum grant procedure may be performed next to the available spectrum information query procedure, or may be performed next to a registration procedure.

In the present embodiment, it is assumed that at least the following two types of spectrum grant request methods can be used.
Designation scheme
Flexible scheme

The designation scheme is a request method in which the communication device 110 designates a desired communication parameter and requests the communication control device 130 to permit operation based on the desired communication parameter. Examples of the desired communication parameter include, but are not particularly limited to, a frequency channel to be used, a maximum transmission power, and the like. For example, a wireless interface technology specific parameter (such as a modulation scheme or a duplex mode) may be designated. Furthermore, information indicating radio wave usage priority such as PAL and GAA may be included.

The flexible scheme is a request method in which the communication device 110 designates only a requirement regarding a communication parameter and requests the communication control device 130 to designate a communication parameter that can be permitted for secondary use while satisfying the requirement. Examples of the requirement related to the communication parameter include, but are not particularly limited to, for example, a bandwidth, a desired maximum transmission power, or a desired minimum transmission power, and the like. For example, a wireless interface technology specific parameter (such as a modulation scheme or a duplex mode) may be designated. Specifically, for example, one or more TDD frame structures may be selected in advance and provided in notification.

Similarly to the query request, the spectrum grant request may also include the measurement report in either the designation scheme or the flexible scheme. The measurement report includes results of measurement performed by the communication device 110 and/or the terminal 120. The measurement may be represented by raw data or processed data. For example, standardized metrics represented by reference signal received power (RSRP), reference signal strength indicator (RSSI), and reference signal received quality (RSRQ) can be used for measurement.

Note that the scheme information used by the communication device 110 may be registered in the communication control device 130 at the time of the registration procedure described in <2.1>.

### <2.3.1 Details of Spectrum Grant Processing>

After receiving the spectrum grant request, the communication control device 130 performs spectrum grant processing on the basis of the spectrum grant request scheme. For example, using the technique described in <2.2>, it is possible to perform the spectrum grant processing in consideration of the primary system, the secondary use prohibited area, the existence of the communication device 110 in the vicinity, and the like.

In a case where the flexible scheme is used, the maximum allowable transmission power information may be derived using the method described in <2.2.2>. Typically, the maximum allowable transmission power information is calculated by using allowable interference power information in the primary system or a protection zone thereof, position information of the reference point for calculating an interference power level suffered by the primary system, registration information of the communication device 110, and a propagation loss estimation model. Specifically, as an example, it is calculated by the above Expression (2).

Furthermore, as described above, Expression (2) is described on the basis of the assumption that the single communication device 110 is an interference source. For example, in a case where it is necessary to consider aggregated interference from a plurality of communication devices 110 at the same time, a correction value may be added. Specifically, for example, the correction value can be determined on the basis of three types of methods (fixed/predetermined, flexible, flexible minimized) disclosed in Non-Patent Document 8 (ECC Report 186).

The communication control device 130 can use various propagation loss estimation models in the spectrum grant procedure, available spectrum evaluation processing for an available spectrum information query request, and the like. In a case where a model is designated for each application, it is desirable to use the designated model. For example, in Non-Patent Document 1 (WINNF-TS-0112), a propagation loss model such as Extended Hata (eHATA) or Irregular Terrain Model (ITM) is employed for each application. Of course, the propagation loss model is not limited thereto.

There are also propagation loss estimation models that require information regarding radio wave propagation paths. The information regarding the radio wave propagation path can include, for example, information indicating inside and outside of a line of sight (Line of Sight (LOS) and/or Non Line of Sight (NLOS)), topographical information (undulations, sea levels, and the like), environmental information (Urban, Suburban, Rural, Open Sky, and the like), and the like. When using the propagation loss estimation model, the communication control device 130 may estimate these pieces of information from the registration information of the communication device 110 or the information of the primary system that is already acquired. Alternatively, in a case where there is a parameter designated in advance, it is desirable to use the parameter.

In a case where the propagation loss estimation model is not designated in a predetermined application, the propagation loss estimation model may be selectively used as necessary. For example, when estimating the interference power to the other communication device 110, a model that is calculated with a small loss such as a free space loss model is used, but when estimating the coverage of the communication device 110, a model that is calculated with a large loss can be used.

Furthermore, in a case where the designated propagation loss estimation model is used, as an example, the spectrum grant processing can be performed by evaluating an interfering risk. Specifically, for example, in a case where it is assumed that desired transmission power indicated by transmission power information is used, when an estimated interference quantity is less than the allowable interference power in the primary system or a protection zone thereof, it is determined that use of the frequency channel can be permitted, and the communication device 110 is notified of the determination.

In any technique of the designation scheme and the flexible scheme, the radio wave usage priority such as PAL or GAA may also be evaluated similarly to the query request. For example, in a case where the registered device parameters or the query requirements include information regarding the radio wave usage priority, it may be determined whether or not it is possible to use a spectrum on the basis of the priority, and the notification may be made. Furthermore, for example, in a case where information regarding the communication device 110 that performs high priority use (for example, PAL) from the user is registered in the communication control device 130 in advance, evaluation may be performed on the basis of the information. For example, in Non-Patent Document 1 (WINNF-TS-0112), information regarding the communication device 110 is referred to as a cluster list.

Furthermore, in any calculation described above, the spectrum availability may be determined by performing correction of the position information or the coverage by using the positioning accuracy information (location uncertainty) when the position information of the communication device is used.

The spectrum grant processing is not necessarily performed due to reception of the spectrum grant request. For example, after the normal completion of the above-described registration procedure, the communication control device 130 may independently perform the spectrum grant processing without the spectrum grant request. Furthermore, for example, the spectrum grant processing may be performed at regular intervals. In such a case, the above-described REM, a lookup table, or information tables similar thereto may be created. Thus, the spectrum that can be permitted is determined only by the position information, and thus the communication control device 130 can quickly return a response after receiving the spectrum grant request.

### <2.4 Spectrum Use Notification (Spectrum Use Notification/Heartbeat)>

The spectrum use notification is a procedure in which the wireless system using the frequency band notifies the communication control device 130 of the use of the spectrum based on the communication parameter allowed to be used in the spectrum grant procedure. The communication device 110 that performs the spectrum use notification as a representative of the wireless system may be the same as or different from the communication device 110 that has performed the procedures so far. Typically, the communication device 110 notifies the communication control device 130 of a notification message including information that can specify the communication device 110.

The spectrum use notification is desirably performed periodically until the use of the spectrum is rejected from the communication control device 130. In that case, the spectrum use notification is also referred to as a heartbeat.

After receiving the spectrum use notification, the communication control device 130 may determine whether to start or continue the spectrum use (in other words, radio wave transmission at the permitted spectrum). Examples of the determination method include confirmation of the spectrum use information of the primary system. Specifically, it is possible to determine permission or rejection of start or continuation of the spectrum use (radio wave transmission at the permitted spectrum) on the basis of a change in the use spectrum of the primary system, a change in a spectrum use situation of the primary system in which the use of radio waves is not steady (for example, a ship radar of CBRS in the United States), and the like. If the start or continuation is permitted, the communication device 110 may start or continue the spectrum use (radio wave transmission at the permitted spectrum).

After receiving the spectrum use notification, the communication control device 130 may command reconfiguration of communication parameters to the communication device 110. Typically, the reconfiguration of communication parameters can be commanded in a response of the communication control device 130 to the spectrum use notification. For example, information regarding recommended communication parameters (hereinafter, recommended communication parameter information) can be provided. The communication device 110 to which the recommended communication parameter information has been provided desirably performs the spectrum grant procedure described in <2.4> again using the recommended communication parameter information.

### <2.5 Supplement of Various Procedures>

The various procedures described above do not necessarily need to be implemented individually, as described below. For example, two different procedures may be implemented by substituting a third procedure having roles of the two different procedures. Specifically, for example, the registration request and the available spectrum information query request may be integrally provided in notification. Furthermore, for example, the spectrum grant procedure and the spectrum use notification may be integrally performed. As a matter of course, it is not limited to these combinations, and three or more procedures may be performed integrally. Furthermore, as described above, one procedure may be separately performed a plurality of times.

Furthermore, the expression “acquisition” or an expression equivalent thereto in the present disclosure does not necessarily mean acquisition according to the procedure described in the present disclosure. For example, although it is described that the position information of the communication device 110 is used in the available spectrum evaluation processing, the information acquired in the registration procedure does not necessarily need to be used, and in a case where position information is included in an available spectrum query procedure request, this position information may be used. In other words, the procedure for acquisition described in the present disclosure is an example, and acquisition by other procedures is also permitted within the scope of the present disclosure and within the scope of technical feasibility.

Furthermore, the information described to be included in the response from the communication control device 130 to the communication device 110 may be actively provided in notification from the communication control device 130 by a push scheme if possible. As a specific example, the available spectrum information, the recommended communication parameter information, a radio wave transmission continuation rejection notification, and the like may be provided in notification by the push scheme.

### <2.6 Various Procedures for Terminal>

So far, the description has been made mainly assuming the processing in the communication device 110A. However, in some embodiments, not only the communication device 110A but also the terminal 120 and the communication device 110B can operate under management of the communication control device 130. That is, a scenario in which the communication parameters are determined by the communication control device 130 is assumed. Even in such a case, basically, the respective procedures described in <2.1> to <2.4> can be used. However, unlike the communication device 110A, the terminal 120 and the communication device 110B need to use the spectrum managed by the communication control device 130 for the backhaul link, and cannot perform radio wave transmission without permission. Therefore, it is desirable to start backhaul communication for the purpose of accessing the communication control device 130 only after detecting a radio wave or an authorization signal transmitted by the communication device 110A (communication device 110 capable of providing wireless communication service or the communication device 110 as a master in a master-secondary system).

On the other hand, under the management of the communication control device 130, there may be cases where, also in the terminal or the communication device 110B, an allowable communication parameter is set for the purpose of protecting the primary system. However, the communication control device 130 is unable to know the position information and the like of these devices in advance. Furthermore, these devices are also likely to have mobility. That is, the position information is dynamically updated. Depending on the laws, in a case where the position information changes by a certain amount or more, re-registration to the communication control device 130 may be required in some cases.

In consideration of such various use forms, operation forms, and the like of the terminal 120 and the communication device 110, in the operation form of the TVWS (Non-Patent Document 9) defined by the Office of Communications (Ofcom), the following two types of communication parameters are defined.
Generic operational parameters
Specific operational parameters

The generic operational parameters are communication parameters defined as “parameters that can be used by any slave WSD located within the coverage area of a predetermined master WSD (corresponding to the communication device 110)” in Non-Patent Document 9. A feature is that it is calculated by a WSDB without using the position information of the slave WSD.

The generic operational parameters can be provided by unicast or broadcast from the communication device 110 that is already permitted to perform radio wave transmission from the communication control device 130. For example, a broadcast signal represented by a contact verification signal (CVS) defined in Part 15 Subpart H of the FCC rule in the United States can be used. Alternatively, it may be provided by a broadcast signal specific to a wireless interface. Therefore, the terminal 120 and the communication device 110B can use the generic operational parameters as the communication parameters used for radio wave transmission for the purpose of accessing the communication control device 130.

The specific operational parameters are communication parameters defined as “parameters that can be used by a specific slave white space device (WSD)” in Non-Patent Document 9. In other words, they are communication parameters calculated using device parameters of the slave WSD corresponding to the terminal 120. A feature is that it is calculated by a white space database (WSDB) using the position information of the slave WSD.

The CPE-CBSD Handshake Procedure defined in Non-Patent Document 7 can be regarded as another form of the procedure related to the terminal. The CPE-CBSD does not have a wired backhaul line and accesses the Internet via the BTS-CBSD. Therefore, permission for radio wave transmission in the CBRS band cannot be acquired from a SAS without a special regulation or procedure. The CPE-CBSD Handshake Procedure allows the CPE-CBSD to perform radio wave transmission at the same maximum EIRP and the minimum necessary duty cycle as those of a terminal (EUD) until permission for radio wave transmission is acquired from the SAS. Accordingly, the communication device 110B can construct a line for acquiring permission for radio wave transmission from the communication control device 130 by setting the transmission EIRP to the maximum EIRP of the terminal and then performing wireless communication with the communication device 110A at the minimum necessary duty cycle. After the permission for the radio wave transmission is acquired, it is possible to use up to the maximum EIRP defined by the communication device within the range of the permission.

### <2.7 Procedure Occurring Between Communication Control Devices>

### <2.7.1 Information Exchange>

The communication control device 130 can exchange management information with another communication control device 130. At least the following information is desirably exchanged.
Information related to communication device 110
Area information
Protection target system information

The information related to the communication device 110 includes at least the registration information and the communication parameter information of the communication device 110 operating under permission of the communication control device 130. The registration information of the communication device 110 having no permitted communication parameter may be included.

The registration information of the communication device 110 is typically the device parameters of the communication device 110 registered in the communication control device 130 in the above-described registration procedure. Not all of the registered information is necessarily exchanged. For example, information that may correspond to personal information does not need to be exchanged. Furthermore, when the registration information of the communication device 110 is exchanged, the registration information may be encrypted and exchanged, or the information may be exchanged after the content of the registration information is made obfuscated. For example, information converted into a binary value or information signed using an electronic signature mechanism may be exchanged.

The communication parameter information of the communication device 110 is typically information related to the communication parameters currently used by the communication device 110. At least information indicating the use spectrum and the transmission power is desirably included. Other communication parameters may be included.

The area information is typically information indicating a predetermined geographical region. This information can include region information of various attributes in various modes.

For example, as in a PAL protection area (PPA) disclosed in Non-Patent Document 1 (WINNF-TS-0112), protection zone information of the communication device 110 serving as a high priority secondary system may be included in the area information. The area information in this case can be expressed by, for example, a set of three or more coordinates indicating a geographical position. Furthermore, for example, in a case where a plurality of the communication control devices 130 can refer to a common external database, the area information is expressed by a unique ID, and the actual geographical region can be referred to from the external database using the ID.

Furthermore, for example, information indicating the coverage of the communication device 110 may be included. The area information in this case can also be expressed by, for example, a set of three or more coordinates indicating a geographical position. Furthermore, for example, assuming that the coverage is a circle centered on the geographical position of the communication device 110, the coverage can also be expressed by information indicating a size of a radius. Furthermore, for example, in a case where a plurality of the communication control devices 130 can refer to a common external database that records area information, the information indicating the coverage is expressed by a unique ID, and the actual coverage can be referred to from the external database using the ID.

Furthermore, as another aspect, information related to an area section determined in advance by the government or the like can also be included. Specifically, for example, it is possible to indicate a certain region by indicating an address. Furthermore, for example, a license area or the like can be similarly expressed.

Furthermore, as still another aspect, the area information does not necessarily express a planar area, and may express a three-dimensional space. For example, it may be expressed using a spatial coordinate system. Furthermore, for example, information indicating a predetermined closed space such as a floor number, a floor, and a room number of a building may be used.

The protection target system information is, for example, information of a wireless system treated as a protection target, such as the aforementioned existing layer (Incumbent Tier). Examples of the situation in which this information needs to be exchanged include, for example, a situation in which cross-border coordination is required. It is well conceivable that different protection targets exist in the same band between neighboring countries or regions. In such a case, the protection target system information can be exchanged between different communication control devices 130 in different countries or regions to which the communication control devices belong as necessary.

As another aspect, the protection target system information may include information of a secondary licensee and information of the wireless system operated by the secondary licensee. The secondary licensee is specifically a lessee of the license, and for example, it is assumed that the secondary licensee borrows PAL from the holder and operates the wireless system owned by itself. In a case where the communication control device 130 performs the rent management independently, information of the secondary licensee and information of the wireless system operated by the secondary licensee can be exchanged with another communication control device for the purpose of protection.

These pieces of information can be exchanged between the communication control devices 130 regardless of the decision-making topology applied to the communication control device 130.

Furthermore, these pieces of information can be exchanged in various schemes. Examples thereof will be described below.
ID designation scheme
Period designation scheme
Region designation scheme
Dump scheme

The ID designation scheme is a scheme in which an ID, given in advance to specify information managed by the communication control device 130, is used to acquire information corresponding to the ID. For example, it is assumed that a first communication control device 130 manages the communication device 110 with ID: AAA. At this time, a second communication control device 130 designates ID: AAA to the first communication control device 130 and makes an information acquisition request. After receiving the request, the first communication control device 130 searches for information of ID: AAA, and provides notification of information regarding the communication device 110 with ID: AAA, for example, registration information, communication parameter information, and the like as a response.

The period designation scheme is a scheme in which information satisfying a predetermined condition can be exchanged in a designated specific period.

Examples of the predetermined condition include the presence or absence of information update. For example, in a case where acquisition of information regarding the communication device 110 in the specific period is designated by a request, the registration information of the communication device 110 newly registered within the specific period can be provided in notification as a response. Furthermore, the registration information or the information of communication parameters of the communication device 110 whose communication parameters have been changed within the specific period can also be provided in notification as a response.

Examples of the predetermined condition include whether or not being recorded by the communication control device 130. For example, in a case where acquisition of information regarding the communication device 110 in the specific period is designated by a request, the registration information or the information of the communication parameters recorded by the communication control device 130 in the period can be provided in notification as a response. In a case where the information is updated in the period, the latest information in the period can be provided in notification. Alternatively, an update history for each piece of the information may be provided in notification.

In the region designation scheme, a specific region is designated, and information of the communication device 110 belonging to the region is exchanged. For example, in a case where acquisition of information regarding the communication device 110 in the specific region is designated by a request, the registration information or the information of the communication parameters of the communication device 110 installed in the region can be provided in notification as a response.

The dump scheme is a scheme of providing the entire information recorded by the communication control device 130. At least the information related to the communication device 110 and the area information are desirably provided by the dump scheme.

The above description of the information exchange between the communication control devices 130 is all based on a pull scheme. That is, a form in which information corresponding to a parameter designated in a request is responded is adopted, and as an example, implementation by the HTTP GET method is possible. However, it is not necessary to be limited to the pull scheme, and information may be actively provided to another communication control device 130 by a push scheme. As an example, the push scheme can be implemented by the HTTP POST method.

### <2.7.2 Command or Request Procedure>

The communication control devices 130 may give a command or a request with each other. Specifically, as an example, there is reconfiguration of communication parameters of the communication device 110. For example, in a case where it is determined that the first communication device 110 managed by the first communication control device 130 is subject to great interference from the second communication device 110 managed by the second communication control device 130, the first communication control device 130 may request the second communication control device 130 to change communication parameters of the second communication device 110.

As another example, there is reconfiguration of the area information. For example, in a case where calculation of coverage information and protection zone information regarding the second communication control device 130 managed by the second communication device 110 is incomplete, the first communication control device 130 may request the second communication control device 130 to reconfigure the area information. Besides this, an area information reconfiguration request may be made for various reasons.

### <2.8 Information Transmission Means>

A notification (signaling) between entities described so far can be implemented via various media. E-UTRA or 5G NR will be described as an example. As a matter of course, the present embodiment is not limited thereto at the time of implementation.

### <2.8.2 Signaling Between Communication Control Device 130 and Communication Device 110>

The notification from the communication device 110 to the communication control device 130 may be performed, for example, in an application layer. For example, the Hyper Text Transfer Protocol (HTTP) may be used. Signaling can be performed by describing required parameters in a message body of the HTTP according to a predetermined manner. Moreover, in a case where the HTTP is used, the notification from the communication control device 130 to the communication device 110 is also performed according to an HTTP response mechanism.

### <2.8.3 Signaling Between Communication Device 110 and Terminal 120>

The notification from the communication device 110 to the terminal 120 may be performed using, for example, at least one of radio resource control (RRC) signaling, system information (SI), or downlink control information (DCI). Furthermore, examples of a downlink physical channel include a physical downlink control channel (PDCCH), a physical downlink shared channel (PDSCH), a physical broadcast channel (PBCH), an NR-PDCCH, an NR-PDSCH, an NR-PBCH, and the like, but the downlink physical channel may be implemented using at least one of these.

The notification from the terminal 120 to the communication device 110 may be performed using, for example, radio resource control (RRC) signaling or uplink control information (UCI). Furthermore, it may be implemented by using an uplink physical channel (physical uplink control channel (PUCCH), physical uplink shared channel (PUSCH), physical random access channel (PRACH)).

The signaling is not limited to the above-described physical layer signaling, and the signaling may be performed at a higher-tier. For example, at the time of implementation at the application layer, the signaling may be implemented by describing a required parameter in a message body of the HTTP according to a predetermined manner.

### <2.8.4 Signaling Between Terminals 120>

FIG. 6 illustrates an example of a flow of signaling in a case where device-to-device (D2D) or vehicle-to-everything (V2X), which is communication between the terminals 120, is assumed as communication of the secondary system. The D2D or V2X which is communication between the terminals 120 may be performed using a physical sidelink channel (a physical sidelink control channel (PSCCH), a physical sidelink shared channel (PSSCH), or a physical sidelink broadcast channel (PSBCH)). The communication control device 130 calculates a communication parameter to be used by the secondary system (T101) and notifies the communication device 110 of the secondary system of the calculated communication parameter (T102). A value of the communication parameter may be determined and provided in notification, or a condition indicating a range or the like of the communication parameter may be determined and provided in notification. The communication device 110 acquires the communication parameter to be used by the secondary system (T103), and sets the communication parameter to be used by the communication device 110 itself (T104). Then, the terminal 120 is notified of a communication parameter to be used by the terminal 120 subordinate to the communication device 110 (T105). Each of the terminals 120 subordinate to the communication device 110 acquires (T106) and sets (T107) the communication parameter to be used by the terminal 120. Then, communication with another terminal 120 of the secondary system is performed (T108).

A communication parameter in a case where a target frequency channel for spectrum sharing is used in the sidelink (direct communication between the terminals 120) may be provided in notification, acquired, or set in a form associated with a resource pool for the sidelink in the target frequency channel. The resource pool is a radio resource for a sidelink set by a specific frequency resource or time resource. Examples of the frequency resource include a resource block, a component carrier, and the like. The time resource includes, for example, a radio frame, a subframe, a slot, a mini-slot, and the like. In a case where the resource pool is set in a frequency channel to be subjected to the spectrum sharing, the resource pool is set in the terminal 120 by the communication device 110 on the basis of at least one of the RRC signaling, the system information, or the downlink control information. Then, a communication parameter to be applied in the resource pool and the sidelink is also set in the terminal 120 by the communication device 110 on the basis of at least one of the RRC signaling, the system information, or the downlink control information from the communication device 110 to the terminal 120. The notification of setting of the resource pool and the notification of the communication parameter to be used in the sidelink may be performed simultaneously or individually.

### 3. EMBODIMENTS OF PRESENT INVENTION

### <3.1 Normal License Lending Procedure>

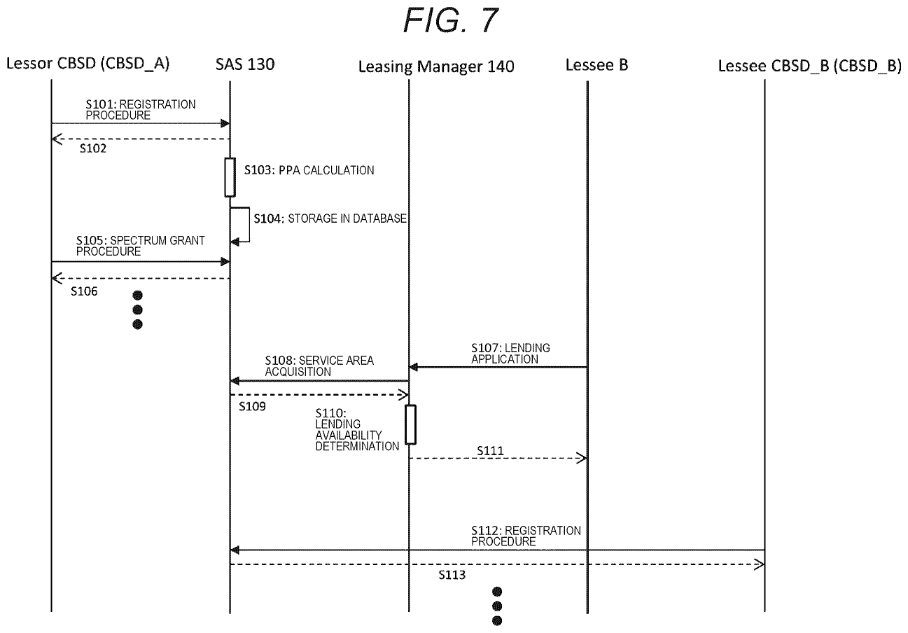

As a related technique of the present embodiment, a normal license lending procedure will be described. It is assumed that the PAL owned by an operator A in a certain County is lent to another operator B other than the operator A. The operator A is referred to as Lessor A, and the operator B is referred to as Lessee B. Lessee B may submit a lending application for a PAL and, if the application is accepted, may be granted a PAL. In order to determine whether to permit the application, a Leasing Manager managed by the SAS Administrator that performs the application procedure to the FCC on behalf can receive a lending application from Lessee B, performs lending availability determination to decide whether or not to permit the application, and answer whether or not to permit the application. FIG. 7 illustrates an example of a flow in a case where the Leasing Manager performs lending availability determination for Lessee B.

FIG. 7 illustrates an example of a flow according to the lending availability determination for Lessee B. Note that a step indicated by a broken line represents a response step. The Leasing Manager 140 may be an entity independent of the SAS 130 or may be provided as one function of the SAS 130.

Let a CBSD installed by Lessor A be CBSD_A. CBSD_A corresponds to Lessor CBSD in FIG. 7. When CBSD_A is registered in the SAS 130 by the above-described registration procedure (S101 and S102), the SAS 130 calculates a PPA, which is a protection area of CBSD_A, for CBSD_A on the basis of EIRP Capability registered by the registration procedure (S103). The EIRP of CBSD_A corresponds to the maximum transmission power of CBSD_A as an example. For the calculation of the PPA, the method disclosed in Non-Patent Document 1, R2-SGN-04 can be used. The PPA calculated for CBSD_A is described as PPA_A. The SAS 130 stores the calculated PPA_A in an internal database or the like (S104).

CBSD_A acquires the permission (grant) of spectrum use from the SAS 130 based on the held PAL by the spectrum grant procedure described above (S105 and S106). The grant includes information of the spectrum allowed to be used, information of the allowable maximum transmission power (allowable transmission power), and the like. More specifically, the SAS 130 determines the allowable transmission power of CBSD_A by performing an iterative allocation process (IAP) in Cooperative Periodic Activities among SASs (CPAS) performed once every 24 hours. The SAS 130 issues, to CBSD_A, the above-described grant that permits the spectrum use with the determined allowable transmission power. Note that the IAP is a method of distributing the interference margin (interference allowable power) of each protection point to each CBSD by repeating reducing the transmission power of each CBSD by a certain quantity (reduction quantity) for each protection target (or protection point) until the accumulated interference quantity to the protection point becomes equal to or less than the threshold (allowable value). Thus, the allowable transmission power of each CBSD can be determined to a power value at which the accumulated interference power from each CBSD to each protection point is equal to or less than the allowable value.

Lessee B, who wishes to rent a license (PAL) from Lessor A, submits or transmits a lending application including information necessary for lending to the Leasing Manager 140 (S107). As a means for applying for lending to the Leasing Manager 140, typically, application on a website, application by e-mail, or the like can be considered. In this case, a device of Lessee B transmits a lending application to the Leasing Manager 140.

Examples of the information necessary for the lending application include the following information.
Position information (latitude and longitude, or the like) of the base station (CBSD_B)
Information regarding an area for which it is desired to borrow a license (PAL) (Shapefile, GeoJSON format, or the like)
Desired maximum transmission power

Upon receiving the lending application including the above information from Lessee B, the Leasing Manager 140 acquires information of the PPA of CBSD_A as information of the service area of CBSD_A of Lessor A from the SAS 130 (S108 and S109). The Leasing Manager 140 determines lending availability of a PAL to Lessee B on the basis of the information of the lending application of Lessee B described above and the information of the service area of CBSD_A of Lessor A (S110), and transmits a determination result indicating lending availability to Lessee B (S111). In a case where the determination result indicating that the PAL is available for lending in the desired rental area is received, Lessee B can perform the registration procedure for using the radio wave in the desired rental area with the SAS 130 (S112 and S113). Thereafter, CBSD_B can further use the spectrum in the desired rental area through a spectrum grant procedure or the like.

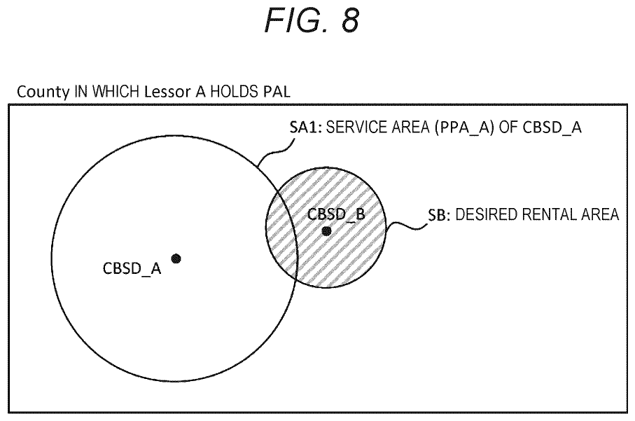

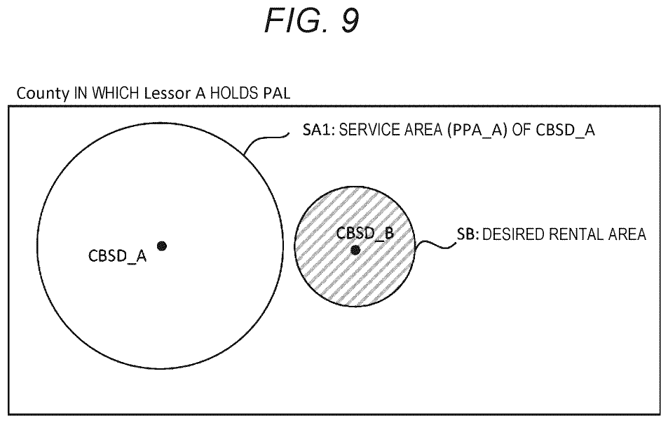

An example of determination of lending availability will be described with reference to FIGS. 8 and 9.

FIG. 8 illustrates an example of a service area SA1 of CBSD_A of Lessor A and the desired rental area SB of Lessee B. In this example, the service area of CBSD_A of Lessor A is the PPA of CBSD_A of Lessor, that is, PPA_A. In a case where PPA_A is used as the service area of CBSD_A of Lessor A, the available lending area for PAL is a range obtained by excluding PPA_A from the range of County in which Lessor A holds PAL. In this example, the service area SA1 of CBSD_A and the desired rental area SB partially overlap. As described above, in a case where even a part of the desired rental area of Lessee B is included in the service area of CBSD_A of Lessor A, the Leasing Manager 140 may reject the lending.

FIG. 9 illustrates another example of the service area SA1 of CBSD_A of Lessor A and the desired rental area SB of Lessee B. Also in this example, the service area of CBSD_A of Lessor A is the PPA of CBSD_A of Lessor, that is, PPA_A. In this example, since all of the desired rental area SB of Lessee B is included in the available lending area and is not included in the service area SA1 (PPA_A) of CBSD_A, the Leasing Manager 140 may permit the lending to Lessee B.

Note that, even in a case where there is an overlap between PPA_A and the desired rental area (see FIG. 8), the Leasing Manager 140 may set an area obtained by removing the overlap from the desired rental area as an actual lending area, and permit the PAL to be lent to Lessee B with respect to the lending area.

Furthermore, the Leasing Manager 140 may determine lending availability of a PAL to Lessee B in consideration of interference from the Lessee's desired rental area to the Lessor's service area, as in a response to a local service area construction request described in Patent Document 1, in addition to simply confirming that the desired rental area is outside PPA_A. Alternatively, the Leasing Manager 140 may determine a new service area of CBSD_B of Lessee on the basis of an interference calculation result, and allow the Lessee B to rent the PAL for the determined service area.

For a grant (PAL Grant) of the PAL CBSD, the SAS 130 implements the IAP in the CPAS for the purpose of protecting the primary system (Incumbent) as a protection target in the higher-tier and protecting the PPA of other PAL CBSDs. Therefore, the transmission power actually allowed for a PAL Grant is often lower than the EIRP Capability used for calculating the PPA. Therefore, the effective service area of the PAL Grant is often smaller than that of the PPA.

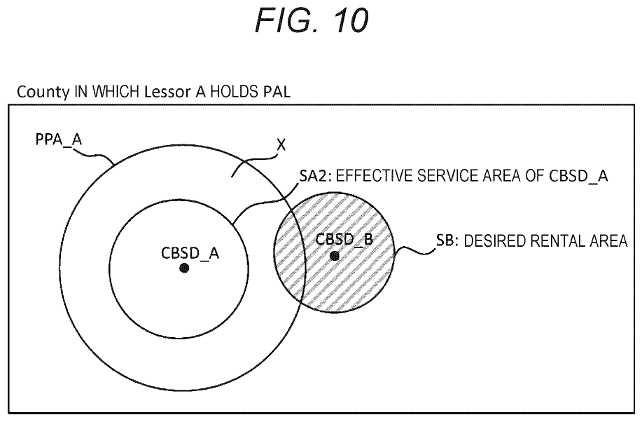

FIG. 10 illustrates a relationship among PPA_A of CBSD_A, a service area SA2 (an effective service area of CBSD_A) based on the allowable transmission power of the PAL Grant of CBSD_A, and a desired rental area SB of Lessee B. The service area SA2 of CBSD_A is narrower than PPA_A, and the desired rental area SB of Lessee B partially overlaps with PPA_A but does not overlap with the service area SA2. The desired rental area SB overlaps only in an area (range) X of the difference between the service area SA2 of CBSD_A and PPA_A. Since this area X is not the service area SA2 of Lessor A, it is originally available for lending to Lessee B. However, in a case where PPA_A is regarded as a service area of Lessor A and lending availability to Lessee B is determined, PALs cannot be lent to Lessee B as long as the desired rental area SB at least partially overlaps with PPA_A. For this reason, opportunities to lend the PAL are not sufficiently used, and opportunities for spectrum use are limited.

### <3.2 License (PAL) Lending Procedure Based on Effective Service Area>

Thus, in the present embodiment, an effective service area is calculated on the basis of the allowable transmission power of the PAL Grant of Lessor (in this example, Lessor A) obtained on the basis of interference calculation such as IAP, and PAL lending availability determination for the Lessee is determined on the basis of the effective service area and the desired rental area of the Lessee (in this example, the Lessee B). According to this, for example, in a case where lending availability is determined based on whether at least a part of the desired rental area overlaps with the effective service area of Lessor, not only the area excluding PPA_A in County in FIG. 10 but also the area X becomes an available lending area. Therefore, the PAL can be lent to CBSD_B having the desired rental area SB. As a result, it is possible for Lessor to increase the number of lending opportunities and the number of spectrum use opportunities. Hereinafter, a communication system that implements such PAL lending according to the present embodiment will be described.

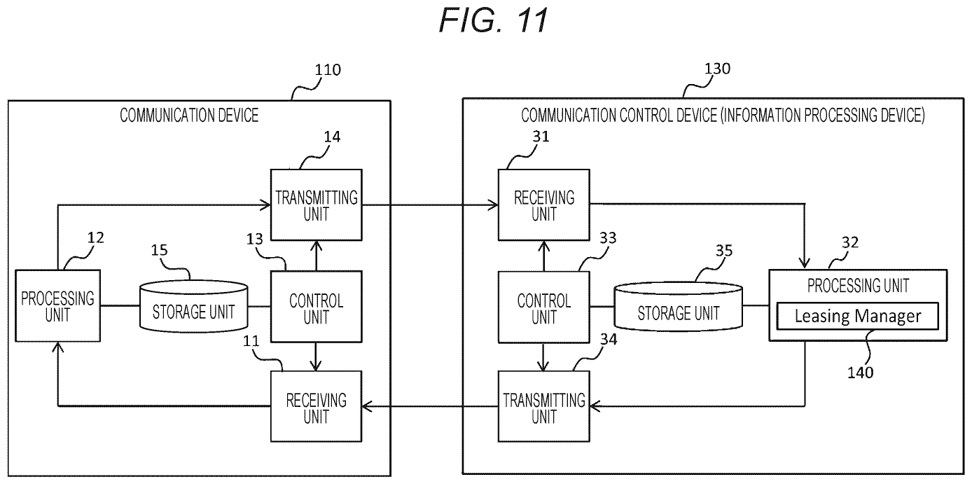

FIG. 11 is a block diagram of the communication system according to the present embodiment. The communication system of FIG. 11 includes the communication device 110 according to the present embodiment and the communication control device 130 that is one form of the information processing device according to the present embodiment. In the present embodiment, CBRS is assumed as a communication standard to be applied, the communication device 110 corresponds to CBSD, and the communication control device 130 corresponds to SAS, but may correspond to different entities according to the communication standard to which the present embodiment is applied. Hereinafter, the communication control device 130 is referred to as a SAS 130, and the communication device 110 is referred to as a CBSD 110 (alternatively, CBSD_A or CBSD_B). Although only one CBSD is illustrated in the drawing, there is actually a plurality of CBSDs. In the present embodiment, at least CBSD_A and CBSD_B exist as CBSDs 110 to be managed by the SAS 130. CBSD_A is a CBSD operated by a first operator having a PAL that is a right to preferentially use radio waves, and corresponds to a first communication device operated by the first operator as an example. CBSD_B is a CBSD that a second operator intends to borrow a PAL from a first operator and operate in a desired lending area in County, and corresponds to a second communication device operated by the second operator as an example. The first operator corresponds to Lessor A that lends the right, and the second operator corresponds to Lessee B that receives the right. In addition, although only one SAS 130 according to the present embodiment is illustrated in the drawing, there may be other SAS in practice. The other SAS manages one or more other CBSDs.

### (SAS 130)

The SAS 130 includes a receiving unit 31, a processing unit 32, a control unit 33, a transmitting unit 34, and a storage unit 35.

The transmitting unit 34 performs processing of transmitting a signal to the CBSD 110 and other SAS in a wireless or wired manner.

The receiving unit 31 performs processing of receiving a signal from the CBSD 110 or another SAS in a wireless or wired manner.

The transmitting unit 34 and the receiving unit 31 may each include at least one antenna in a case where transmission and reception are performed wirelessly with another device.

The control unit 33 controls the entire SAS 130 by controlling each element in the SAS 130.

The storage unit 35 of the SAS 130 stores in advance various types of information necessary for communication with the CBSD 110 and other SAS. As an example, the storage unit 35 stores information of the CBSD 110 registered in the above-described registration procedure. For example, information such as an ID, position information, maximum transmission power information (EIRP capability value, maximum antenna power (maximum conducted power), and the like), dynamic beam pattern information (beam movable range information), antenna transmission power (conducted power) of the CBSD 110, and the like are stored. In addition, the storage unit 35 stores information of the PAL Grant issued from the SAS 130 to the CBSD 110. The information of the PAL Grant includes, for example, an ID of the PAL Grant, a spectrum allowed to be used by the CBSD 110, allowable transmission power, a beam pattern, and the like.

The processing unit 32 performs various types of processing according to the present embodiment. For example, the processing unit 32 performs processing related to a registration procedure, a frequency usage inquiry procedure, and a spectrum grant procedure with the CBSD 110.

Furthermore, the processing unit 32 calculates the PPA in response to the request from the CBSD 110, and transmits the calculation result of the PPA to the CBSD 110.

In addition, the processing unit 32 performs processing called Coordinated Periodic Activities among SASs (CPAS) with one or more other SAS. The CPAS is processing performed once every 24 hours among a plurality of SASs, and calculation processing related to high-tier protection such as Incumbent and calculation processing related to PPA protection are performed. The processing unit 32 determines the allowable transmission power of the CBSD 110 by the IAP in the CPAS. That is, the processing unit 32 determines, for each CBSD, the allowable transmission power at which the quantity of interference with the protection target (such as Incumbent) equal to or less than the allowable value. The quantity of interference with the protection target (such as Incumbent) being equal to or less than an allowable value specifically means, for example, that the quantity of interference with any one or more protection points (calculation points) related to the protection target is equal to or less than an allowable value.

The processing unit 32 notifies the CBSD 110 of the information indicating the determined allowable transmission power together with the information indicating the available spectrum in association with the PAL Grant. As the timing for notifying the information, there may be a timing for responding to an available spectrum procedure to the CBSD 110, a timing for transmitting a response in the spectrum grant procedure, and any other timings.

The processing unit 32 determines effective service area information of CBSD_A according to the present embodiment on the basis of the allowable transmission power of the radio wave transmitted from CBSD_A obtained by the IAP. The processing unit 32 stores information of the determined effective service area in the storage unit 35. Since the allowable transmission power is usually set to a value smaller than the maximum transmission power of CBSD_A, the effective service area of CBSD_A is an area smaller than the PPA (PPA_A) of CBSD_A calculated on the basis of EIRP. The effective service area of CBSD_A can also be said to be the coverage of CBSD_A.

The processing unit 32 includes the function of the Leasing Manager 140 according to the present embodiment. As an example of the function of the Leasing Manager 140, the processing unit 32 receives a lending application including information of the desired rental area of PAL of CBSD_B from the device of Lessee B or CBSD_B, and determines lending availability of PAL for Lessee B on the basis of information of the effective service area of CBSD_A acquired from the storage unit 35 and the information of the desired rental area. The processing unit 32 transmits response information indicating determination of lending availability to the device or CBSD_B of Lessee B. In a case where CBSD_B obtains a PAL lending permission in the desired rental area, CBSD_B can request the above-described registration procedure, spectrum grant procedure, and the like to SAS 130 on the basis of the rented PAL to the desired rental area. Note that the Leasing Manager 140 may extract some effective service areas on the basis of the desired rental area of CBSD_B instead of acquiring the information of the effective service area of all CBSD_A. Furthermore, the Leasing Manager 140 may determine the information of the effective service area of CBSD_A each time on the basis of the allowable transmission power of the radio wave transmitted from CBSD_A acquired from the storage device 35. CBSD_A at this time may be extracted on the basis of the desired rental area of CBSD_B.

Each processing block of the SAS 130 is constituted by a hardware circuit, software (program or the like), or both of them. The function of the SAS 130 may be implemented by causing a computer to execute a program. The storage unit 35 is constituted by any hardware such as a memory device, a magnetic storage device, and an optical disk. The storage unit 35 may include a database. The storage unit 35 may be externally connected to the SAS 130 not in the SAS 130 but in a wired or wireless manner. The transmitting unit 34 and the receiving unit 31 in the SAS 130 may include one or a plurality of network interfaces depending on the number or type of connectable networks.

### (CBSD 110)

The CBSD 110 includes a receiving unit 11, a processing unit 12, a control unit 13, a transmitting unit 14, and a storage unit 15. The transmitting unit 14 and the receiving unit 11 each include at least one antenna.

The transmitting unit 14 performs a process of transmitting a signal to the SAS 130 and the other CBSDs 110 in a wireless or wired manner. Furthermore, the transmitting unit 14 performs processing of transmitting a signal wirelessly or by wire with the terminal 120 within the coverage or the effective service area of the CBSD 110.

The receiving unit 11 performs a process of receiving a signal from the SAS 130 or another CBSD 110 in a wireless or wired manner. Furthermore, the receiving unit 11 performs processing of receiving a signal wirelessly or by wire from the terminal 120 within the coverage or the effective service area of the CBSD 110.

The control unit 13 controls the entire CBSD 110 by controlling each element in the CBSD 110. For example, the control unit 13 may control beamforming of the transmitting unit 14 or beamforming of the receiving unit 11.

The storage unit 15 of the CBSD 110 stores in advance various types of information necessary for communication with communication with the SAS 130, other CBSDs 110, or the like. Furthermore, the storage unit 15 stores information regarding various performance, specifications, and the like of the CBSD 110. For example, the storage unit 15 stores information such as an ID, position information, maximum transmission power information (EIRP capability value, maximum antenna power (maximum conducted power), and the like), dynamic beam pattern information (beam movable range information), antenna transmission power (conducted power) of the CBSD 110, and the like.

The processing unit 12 performs various types of processing according to the present embodiment. For example, the processing unit 12 performs processing related to various procedures described above, for example, a registration procedure, a spectrum use inquiry procedure, or a spectrum grant procedure, with the SAS 130.

Furthermore, in a case where the CBSD 110 is Lessee's CBSD (CBSD_B), the processing unit 12 may perform the processing related to the PAL lending application. The processing unit 12 of CBSD_B transmits, to the Leasing Manager 140, a lending application that includes information of an area in which Lessee desires to operate CBSD_B (desired rental area) and applies for lending of a right to preferentially use a radio wave in the desired rental area. The processing unit 12 of CBSD_B receives, from the Leasing Manager 140, response information including the availability of the PAL determined by the Leasing Manager 140 on the basis of the information of the effective service area of CBSD_A operated by Lessor and the information of the desired rental area. The processing unit 12 performs various procedures with the SAS 130 on the basis of the response information. For example, the processing unit 12 transmits, as a registration procedure, a registration request for registering information of CBSD_B for use of a radio wave in the desired rental area.

Each processing block of the CBSD 110 is constituted by a hardware circuit, software (program or the like), or both of them. The function of the CBSD 110 may be implemented by causing a computer to execute a program. The storage unit 15 includes any storage device such as a memory device, a magnetic storage device, or an optical disk. The storage unit 15 may include a database. The storage unit 15 may be externally connected to the CBSD 110 not in the CBSD 110 but in a wired or wireless manner. The transmitting unit 14 and the receiving unit 11 in the CBSD 110 may include one or a plurality of network interfaces according to the number or type of connectable networks.

In the example of FIG. 11, the Leasing Manager 140 is a part of the function of the SAS 130, but the Leasing Manager 140 may be provided as an information processing device independent of the SAS 130.

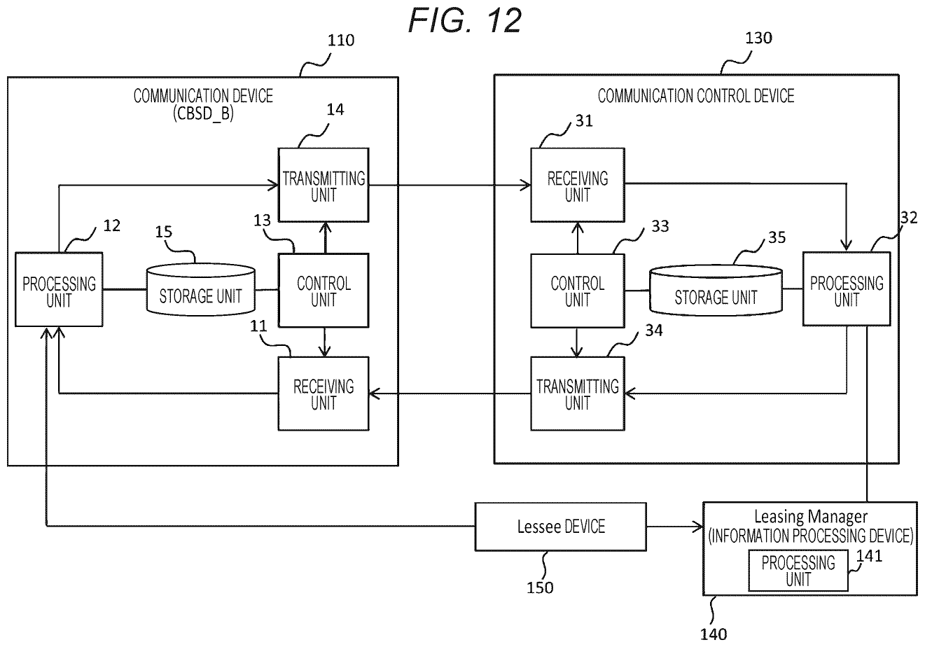

FIG. 12 illustrates a configuration example in a case where the Leasing Manager 140 is provided as an information processing device independent of the SAS 130. Here, it is assumed that the CBSD 110 is CBSD_B. The Leasing Manager 140 is connected to the SAS 130 in a wired or wireless manner so as to be able to exchange information with the processing unit 32 of the SAS 130. The Leasing Manager 140 includes a processing unit 141 that performs processing similar to a case provided in the communication control device 130. Note that the SAS 130 may perform information communication with the Leasing Manager 140 via the receiving unit 31 and the transmitting unit 34, or may perform information communication with the Leasing Manager 140 via a communication interface different from the receiving unit 31 and the transmitting unit 34.

Furthermore, the Leasing Manager 140 can acquire various instructions or data from a device 150 of Lessee B. Furthermore, the processing unit of the CBSD 110 (here, CBSD_B) can acquire various instructions or data from the device 150 of Lessee B. In a case where the device 150 is added to FIG. 11 in the configuration of FIG. 11 described above, the processing unit 32 of the SAS 130 may be able to acquire various instructions or data from the device 150 of Lessee B.

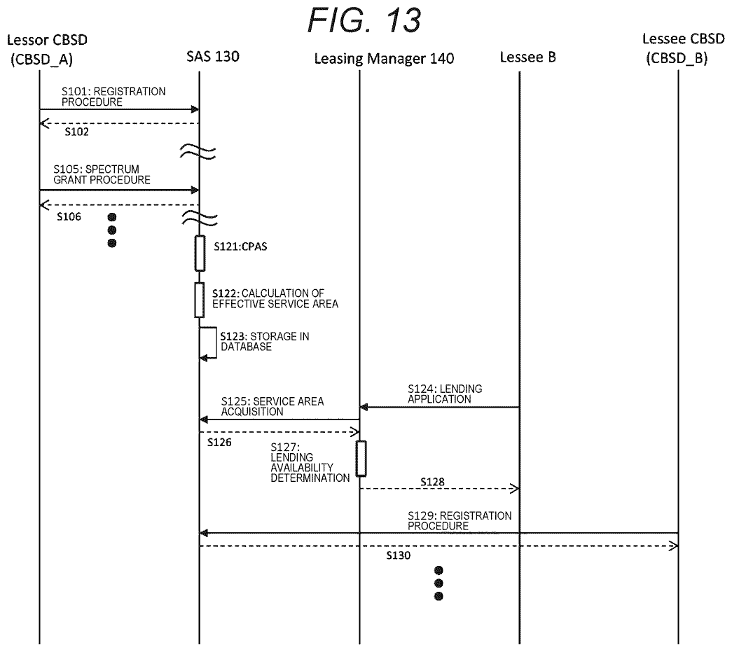

FIG. 13 illustrates an example of a flow of PAL lending availability determination for Lessee according to the present embodiment. Note that a step indicated by a broken line represents a response step. The registration procedure in steps S101 and S102 and the spectrum grant procedure in steps S105 and S106 are the same as those in FIG. 7. Note that although not illustrated in FIG. 13, steps S102 and S105 are performed between steps S103 and S104 as in FIG. 7. In the following description, the processing to be performed by the SAS 130, CBSD_A, CBSD_B, and the Leasing Manager 140 is performed by the processing units included therein.

The SAS 130 determines the allowable transmission power by the CPAS for the PAL Grant of Lessor A obtained in the spectrum grant procedure (S121). The SAS 130 calculates an effective service area of CBSD_A based on the allowable transmission power (S122), and stores information of the effective service area in the storage unit 35 (database or the like) (S123). Note that the calculation of the effective service area based on the allowable transmission power can be performed by using the allowable transmission power of the PAL Grant instead of the EIRP capability in the method disclosed in Non-Patent Document 1R2-SGN-04. More specifically, during the CPAS, the SAS 130 obtains the allowable transmission power of the PAL Grant of CBSD_A by the IAP for each PPA of the upper layer protection target (Incumbent) or other CBSDs, and sets the minimum value of all the obtained allowable transmission powers as the final allowable transmission power. The SAS 130 calculates an effective service area by using this final allowable transmission power.

However, in some cases, instead of the calculated minimum value of all the allowable transmission power, the minimum value of the allowable transmission power for one or more specific Incidents may be obtained, and the effective service area may be calculated using the obtained minimum value. Alternatively, the minimum value may be specified from the allowable transmission power calculated for other than the specific PPA, and the effective service area may be calculated using the specified minimum value. For example, a minimum value may be specified from allowable transmission power other than the allowable transmission power calculated for the Lessee PPA among all the calculated allowable transmission power, and an effective service area may be calculated using the specified minimum value.

The Leasing Manager 140 receives a lending application from the Lessee B device (S124). The information included in the lending application is as described above. The Leasing Manager 140 acquires information of the effective service area of CBSD_A from the SAS 130 (S125 and S126), and determines lending availability of PALs to Lessee B on the basis of the desired rental area of Lessee B and the effective service area of CBSD_A (S127). The Leasing Manager 140 transmits response information including a determination result of lending availability to the Lessee B's device (S128).

As an example of determination of lending availability, it may be determined whether or not at least a part of the desired rental area of Lessee B is included in an effective service area of the PAL Grant of Lessor A, and in a case where at least a part of the area is not included in the effective service area, lending may be permitted. Alternatively, the lending determination may be performed in consideration of interference from the desired rental area (CBSD_B) to an effective service area (for example, if the quantity of interference from CBSD_B to any point within the effective service area is equal to or less than a threshold, lending may be permitted). Alternatively, a new service area of Lessee B available for lending may be created (for example, a service area of CBSD_B is created by limiting the transmission power of CBSD_B, or a service area in which a range included in an effective service area is excluded from the desired rental area of Lessee B is set as the service area of CBSD_B).

Note that, in a case where the CPAS has never been executed before execution of the CPAS in step S121 and the allowable transmission power of the PAL Grant has not been determined, the effective service area cannot be calculated, and thus the Leasing Manager 140 may determine lending availability on the basis of the PPA (PPA_A) of CBSD_A.

In a case where it is determined that the PAL is available for rent in the desired rental area, CBSD_B of Lessee B may perform a series of procedures starting from the registration procedure on the SAS (S129 and S130). Note that, in the CPAS after the Grant of CBSD_B of Lessee B is actually registered by the SAS 130, the SAS 130 can calculate the transmission power allowed for the Grant of Lessee B by the IAP in consideration of the interference power (interference quantity) of Lessor A with respect to the PPA. Thus, there may be a case where the service area of Lessee B is smaller than the desired rental area.

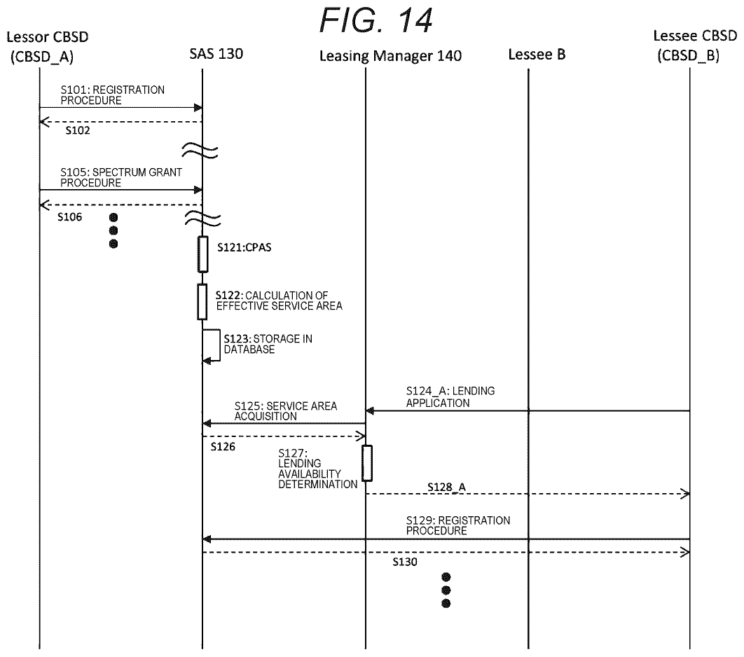

FIG. 14 illustrates an example of a flow of PAL lending availability determination for Lessee based on an effective service area according to the present embodiment. In FIG. 13, the lending application is transmitted from the device of Lessee B to the Leasing Manager 140, but in FIG. 14, the lending application is transmitted from CBSD_B (S124_A). Furthermore, in FIG. 13, the response information including the determination result of the lending availability determination is transmitted from the Leasing Manager 140 to the Lessee B device, but in FIG. 14, the response information is transmitted from the Leasing Manager 140 to the CBSD_B. The other steps are similar to those in FIG. 13.

In the present embodiment, if the desired rental area does not overlap the effective service area SA2 of CBSD_A, even if CBSD_B of Lessee B is located in PPA_A of CBSD_A, it may be possible to rent a PAL. That is, even if CBSD_B is located in the area X, which is an area outside the effective service area SA2 of the Grant of CBSD_A of Lessor A and within PPA_A based on EIRP Capability, it is possible to lend a PAL.

Alternatively, even if CBSD_B of Lessee B is located in PPA_A of CBSD_A, as long as it is outside the effective service area SA2 of CBSD_A, even if the desired rental area overlaps with the effective service area SA2 of CBSD_A, the PAL may be permitted to be lent.

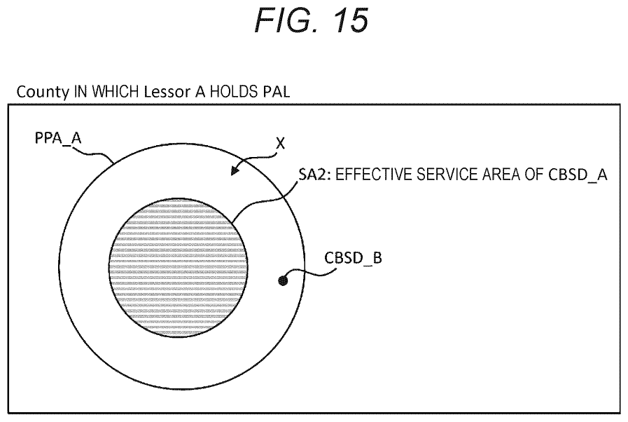

FIG. 15 illustrates an example in which CBSD_B of Lessee B is located in the area X outside the effective service area SA2 of CBSD_A and in PPA_A of CBSD_A. The area X corresponds to a first area obtained by excluding the effective service area from the protection area of CBSD_A.

In this case, as usual, in a case where the SAS performs calculation of interference from the Grant of CBSD_B of Lessee B to the PPA based on EIRP Capability of Lessor A in the IAP, the interference power becomes equal to the transmission power of the Grant of CBSD_B, and therefore transmission cannot be allowed for the Grant of CBSD_B included in PPA_A. Furthermore, such an event can occur as long as CBSD_B is located near the area X even if CBSD_B is not located in the area X. Thus, only when the interference from the Grant of CBSD_B of Lessee B to PPA_A of Lessor A is calculated, the SAS 130 may perform the IAP with the interference from the Grant of CBSD_B existing in X or existing within a certain distance from X as 0 for the calculation point included in the area X, and determine the allowable transmission power for the Grant of CBSD_B.

Note that the Grant that sets the interference to the area X to 0 does not necessarily need to be determined on the basis of a criterion that CBSD_B exists in the area X or CBSD_B is located within a certain distance from the area X. For the calculation point in the effective service area SA2, since the IAP is implemented in consideration of all interference including the interference from the Grant of CBSD_B as usual, the protection of the effective service area SA2 of CBSD_A is guaranteed. In this case, since the IAP determines the allowable transmission power of the Grant of CBSD_B installed in the area X necessary for protecting the effective service area SA2 of the Grant of CBSD_A, it can be said that the effective service area SA2 of CBSD_A is a substantial PPA for the Grant of CBSD_B.

Note that, in a case where such an IAP is implemented, it is necessary to include, as parameters, the former or both of information of the effective coverage (effective service area SA2) and the relationship between Lessor A and Lessee B (the relationship that Lessee has rent a PAL from Lessor), and then the SAS 130 exchanges information with other SASs and performs similar calculation for all the SASs.

If another SAS does not perform calculation similar to that of the SAS 130, a difference occurs in the calculation result between the SASs. Therefore, as described in REL2-R3-SGN-06 and REL2-R3-SGN-07 of Non-Patent Document 10, the SAS 130 may execute the operation of the present embodiment only in a case where all the SASs that manage each CBSD included in the neighborhood of a certain protection target (PPA_A of Lessor A in this case) implement a function similar to that of the SAS 130, or only in a case where all the CBSDs existing in the neighborhood are the CBSDs managed by the SAS 130. The range of the vicinity of a certain protection target may be determined by, for example, the size of the radius of a circle centered on the protection target, or may be determined by another method.

Further, by lending the PAL to Lessee B on the basis of the effective coverage (effective service area SA2), in a case where the CBSD of Lessee increases around CBSD_A of Lessor A, a large amount of interference budget is also allocated to the Grant of CBSD of Lessee by the IAP or the like for a protecting protection target other than CBSD_A of Lessor A, and as a result, there is a possibility that transmission power permitted to the Grant of CBSD_A of Lessor A decreases. Thus, when performing PAL lending availability determination for Lessee, limitation on transmission power of the Grant of CBSD of Lessee may be added as a condition for permitting lending to Lessee. Since the calculation of the IAP or the like with respect to the protection target is performed by using the magnitude of the power required when each CBSD acquires the Grant, the interference budget allocated to the Grant of the CBSD of Lessee can be reduced by limiting this value. Note that such limitation on the transmission power needs to be performed before the CBSD of Lessee requests the SAS 130 to issue a Grant, for example, at the time of lending the PAL to Lessee.

As the limitation on the transmission power of Lessee to the Grant of CBSD, for example, the maximum value is uniformly set to a predetermined value. The maximum value of the transmission power at this time may be changed according to the position of the CBSD of Lessee. For example, different maximum values may be set in the effective service area SA2 of Lessor A, in PPA_A, or in other areas. Alternatively, the maximum value of the transmission power may be set on the basis of the distance from CBSD_A, the distance from the effective service area SA2, the distance from PPA_A, or the like. At this time, a threshold may be set for the distance, and a fixed maximum value may be set for each range partitioned by the threshold. Alternatively, the maximum value may be set on the basis of an equation depending on the distance.

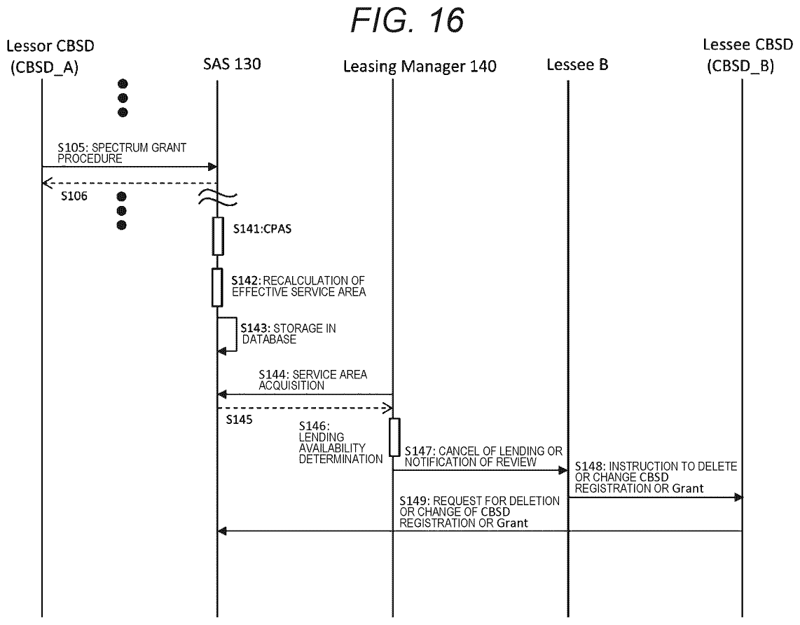

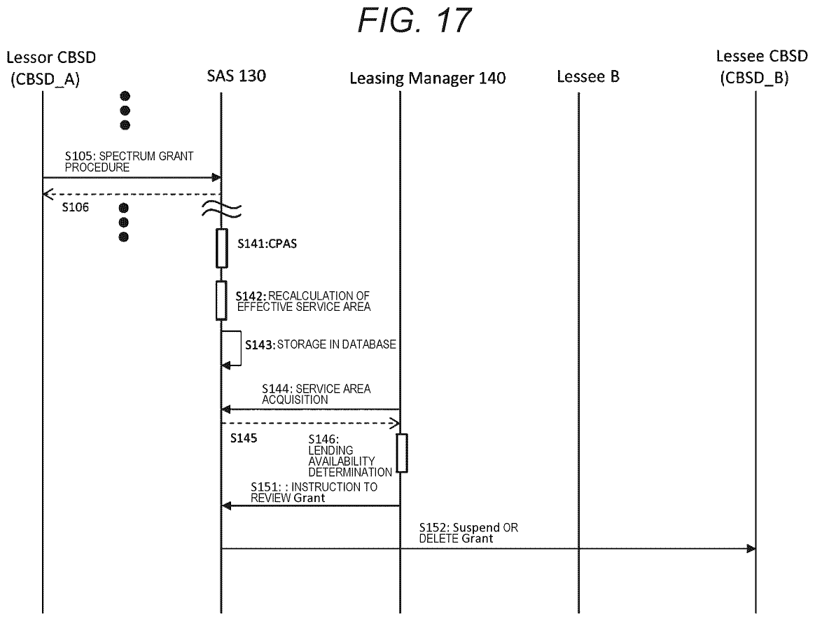

Furthermore, even in a case where the size of the effective service area SA2 of the CBSD_A changes due to an increase or decrease in a protection target other than the CBSD_A of Lessor A, for example, the primary system (Incumbent) or another PAL CBSD, the protection of the effective service area SA2 itself is guaranteed by the CPAS. On the other hand, there is also a possibility that Lessor A makes a request to review lending to Lessee B (for example, cancel the lending) in order to expand the service area. Thus, whenever the size of the effective service area SA2 of CBSD_A of Lessor A changes, the Leasing Manager 140 may re-execute the determination of lending availability. An example of a flow at that time is illustrated in each of FIGS. 16 and 17.

FIG. 16 illustrates an example of a flow of processing involving re-execution of determination of lending availability.

The SAS 130 performs the CPAS or the like (S141), recalculates an effective service area and stores the information in the database (S142 and S143), and the Leasing Manager 140 acquires information of the effective service area (S144 and S145). Then, the Leasing Manager 140 determines again lending availability for a Lessee (Lessee B) to which the PAL is currently lent on the basis of the acquired information of the service area (S146). Note that this determination may be made on the basis of a request from Lessor A who performs lending, or may be made periodically at regular intervals. In a case where the result of the lending determination changes on the basis of the new service area, that is, in a case where it is determined to reject lending, the Leasing Manager 140 transmits a review instruction including at least one of canceling lending, changing the maximum transmission power (allowable transmission power), or changing the range of the lending area to the device of Lessee B (S147). Upon receiving this instruction, the device of Lessee B or Lessee B determines deletion of registration of the Lessee CBSD (CBSD_B) from the SAS 130, or deletion or change of the Grant (changing the maximum transmission power, changing the range of the lending area, or the like), and transmits an instruction to execute the determined content to the Lessee CBSD (CBSD_B) (S148). In accordance with the received instruction, the Lessee CBSD (CBSD_B) transmits a request for deletion of registration, or deletion or change of the Grant (changing the maximum transmission power, changing the range of the lending area, or the like) to the SAS 130 (S149). The SAS 130 executes processing in accordance with the request. In a case where the registration is deleted or the Grant is deleted, thereafter, the Lessee B may review the transmission power or the desired rental area and make a lending application to the Leasing Manager 140 again. Although the review instruction is transmitted to the device of Lessee B in step S147, the review instruction may be transmitted to CBSD_B. In this case, it is sufficient that CBSD_B performs an operation similar to step S149 according to the review instruction.

FIG. 17 illustrates another example of a flow of processing involving re-execution of determination of lending availability. Steps up to step S146 are the same as those in FIG. 16. In a case where the Leasing Manager 140 determines to reject lending in step S146, an instruction to review (suspend or delete) the Grant is transmitted to the SAS 130 in subsequent step S151 (S151). The SAS 130 suspends or deletes the corresponding Grant according to the instruction, and transmits information indicating a result of the processing to the CBSD_B (S152). Thus, the transmission of the radio wave of CBSD_B is stopped. Thereafter, the device of the Lessee B may transmit the lending application to the Leasing Manager 140 again (see step S124 in FIG. 13).

Note that a method of transmitting an instruction from the Leasing Manager 140 to the Lessee B device and a protocol for operating the Lessee CBSD (CBSD_B) from the Lessee B device are not currently specified in any document in the CBRS. Therefore, in a case where these processes are applied in the CBRS, a person may manually operate the device of the Leasing Manager 140 or Lessee B, or the device of the Leasing Manager 140 or Lessee B may operate according to a protocol independently determined. Alternatively, in a case where the automated PAL lending mechanism is systematized in the future, the operation between the Leasing Manager 140 and the Lessee B device or the operation between the Lessee B device and the Lessee CBSD (CBSD_B) may be automatically performed on the basis of the mechanism defined in the system.

### (Modification 1)

Instead of separately handling the PPA (PPA_A) of CBSD_A and the effective service area of CBSD_A, the effective service area of CBSD_ is handled as the actual PPA of CBSD_A, so that transmission of the Grant of CBSD_B may be permitted (allowable transmission power for the Grant of CBSD_B is determined by the IAP in the CPAS). In this case, not only the Grant of CBSD_B but also the Grant of other PALs and the Grant of GAA are protected as the PPA only in the effective service area. Note that, in this case, the SAS 130 only needs to exchange information with another SAS using the effective service area of CBSD_A as the PPA of CBSD_A, and the other SAS need not support the function of the SAS 130 according to the present embodiment.

### Modification 2

By using an area obtained by removing an area overlapping with the desired rental area in which lending to Lessee B is permitted from the PPA (PPA_A) of CBSD_A as a new PPA of CBSD_A or an effective service area of CBSD_A, this area may be excluded from the target of the IAP, and transmission of the Grant of CBSD_B may be permitted. An area where the desired rental area and the PPA (PPA_A) of CBSD_A overlap corresponds to a second area where the desired rental area and the protection area overlap.

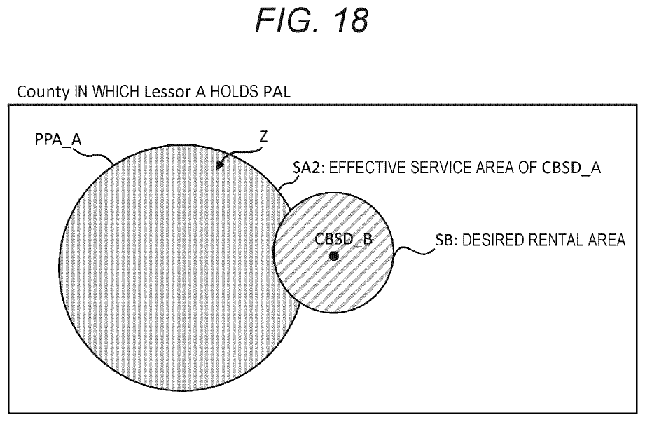

FIG. 18 illustrates an example in which an area Z obtained by excluding an area overlapping the desired rental area SB of Lessee B from PPA_A of CBSD_A is set as an effective service area of CBSD_A.

Since the SAS 130 only needs to exchange information of a new PPA (area Z) with another SAS, the other SAS does not need to support a function equivalent to that of the SAS 130 according to the present embodiment.

### Modification 3

The PAL lending condition for CBSD_B desired to be installed in the area X (first area) in FIG. 15 may be limited to a case where CBSD_B is installed indoors and CBSD_A is installed outdoors. That is, only in a case where CBSD_B is installed indoors and CBSD_A is installed outdoors, PAL lending in a case where CBSD_B is installed in the area X may be permitted. When the quantity of interference (interference power) from CBSD_B to the calculation point in the area X is calculated for the Grant of CBSD_B in the IAP in the CPAS, the allowable transmission power of the Grant of CBSD_B may be calculated assuming that the quantity of interference from CBSD_B is 0.

If CBSD_A is installed outdoors, in the area X located at an end of the coverage (effective service area) of CBSD_A, interference from CBSD_B indoors to a terminal present in the area X can be said to be very small, and thus, even if the interference quantity is assumed to be 0, it can be said that there is no significant influence. Furthermore, under this condition, the interference itself from CBSD_B to the entire coverage of CBSD_A is also very small, and thus it is also possible to similarly assume that the quantity of interference is 0 for not only the area X but also the entire PPA_A including the effective service area of CBSD_A inside the area X. In this case, the maximum transmission power is always allowed for the Grant of CBSD_B in the interference calculation for PPA_A. In addition, even in a case where the conditions of the installation places of CBSD_A and CBSD_B are not confirmed at the time of permitting lending, the installation places of CBSD_A and CBSD_B may be confirmed at the time of calculating the interference quantity, and the allowable transmission power of the Grant of CBSD_B may be calculated assuming that the interference quantity from CBSD_B is 0 in a case where CBSD_A is outdoors and CBSD_B is indoors.

Note that the lending condition and a condition for setting the interference quantity to 0 may include, contrary to the above, a case where CBSD_A is installed indoors and CBSD_B is installed outdoors, or a case where CBSD_A and CBSD_B are installed in different buildings. Alternatively, in a case where other conditions are satisfied in which the interference from CBSD_B to the terminal within the coverage of CBSD_A becomes very small under outdoor or non-indoor conditions, lending may be similarly permitted or the interference quantity may be assumed to be 0.

Note that the SAS 130 performs interference calculation as usual for the IAP for other Incidents, the IAP for PPAs other than PPA (PPA_A) of CBSD_A, and dynamic protection area (DPA) move list calculation. Furthermore, information of whether CBSD_A and CBSD_B are installed indoors may be notified in any procedure (for example, a registration procedure) performed between CBSD_A and CBSD_B and SAS. Alternatively, the SAS 130 may determine whether CBSD_A and CBSD_B are installed indoors by itself using 3D map data including building information.

Similarly, in a case where it is ensured that interference from CBSD_B to a terminal within coverage of CBSD_A is very small, such as in a case where CBSD_B is installed indoors and CBSD_A is installed outdoors, or the like, an additional loss may be added to calculate an interference quantity when calculating interference from a Grant of CBSD_B to the entire area X or PPA_A in the IAP. Adding additional loss means estimating a lower quantity of interference from CBSD_B. As an example of this additional loss, for example, it is possible to consider Building Entry Loss (BEL), which is a loss when a radio wave enters a building. In this case, even in a case where CBSD_B exists in the area X, the quantity of interference with the coverage of CBSD_A such as the area X or PPA_A is calculated to be low, and thus there is a high possibility that transmission of the Grant of CBSD_B is permitted (for example, the allowable transmission power becomes equal to or greater than the reference value).

Furthermore, in a case where CBSD_A is installed outdoors, the SAS 130 can separately calculate a service area (indoor service area) in a case where a terminal to be accommodated is installed indoors, which is calculated in consideration of BEL, in addition to a normal effective service area (outdoor service area) calculated assuming that an accommodated terminal within the coverage of CBSD_A is installed outdoors.

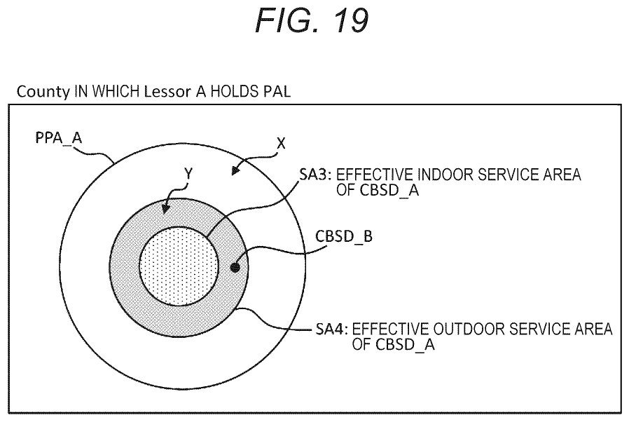

FIG. 19 illustrates an example in which an indoor service area SA3 is separately calculated in the outdoor service area SA4 of CBSD_A.

An area inside the outdoor service area SA4 and outside the indoor service area SA3 is defined as an area Y. The area Y corresponds to a third area inside the outdoor service area and outside the indoor service area. Also for the area Y, the Leasing Manager 140 may permit lending of the PAL to Lessee only if it is guaranteed that the CBSD_B of Lessee is installed indoors. In addition, when calculating the quantity of interference from the Grant of CBSD_B with respect to a calculation point in the area Y in the IAP of the CPAS, the quantity of interference may be set to 0, or the quantity of interference may be calculated in consideration of an additional loss such as BEL. On the other hand, with respect to interference to a calculation point in the indoor service area SA3, there is a possibility that CBSD_A and CBSD_B exist in the same building, and thus it is necessary to perform interference calculation as usual. That is, in this case, the interference quantity is not set to 0, and the BEL is not considered.

Note that the embodiment described above represents an example for embodying the present disclosure, and the present disclosure can be implemented in various other modes. For example, various modifications, replacements, omissions, or combinations thereof can be made without departing from the gist of the present disclosure. Such modifications, substitutions, omissions, and the like are also included in the scope of the present disclosure, and are similarly included in the inventions disclosed in the claims and the equivalents thereof.

Furthermore, the effects of the present disclosure described in the present specification are merely an example, and there may be other effects.

Note that, the present disclosure can also have the following configurations.

### [Item 1]

An information processing device including:
a processing unit that acquires information of an effective service area of a first communication device operated by a first operator that has a right to preferentially use a radio wave, on the basis of allowable transmission power of the radio wave transmitted from the first communication device, and
determines availability of lending of the right to a second operator that operates a second communication device, on the basis of the information of the effective service area of the first communication device and information of a desired rental area where the second operator desires to operate the second communication device.

### [Item 2]

The information processing device according to item 1, in which
the processing unit permits lending of the right in a case where the desired rental area does not overlap with the service area of the first communication device.

### [Item 3]

The information processing device according to item 1 or 2, in which
in a case where an installation position of the second communication device is outside the effective service area of the first communication device and included in a protection area of the first communication device, the processing unit permits lending of the right.

### [Item 4]

The information processing device according to any one of items 1 to 3, in which
the processing unit calculates the allowable transmission power of the radio wave transmitted from the first communication device for each of a plurality of protection targets, and calculates the effective service area of the first communication device on the basis of a minimum value of the allowable transmission power calculated for each of the plurality of protection targets.

### [Item 5]

The information processing device according to any one of items 1 to 4, in which
the processing unit determines allowable transmission power of a radio wave transmitted from the second communication device for which the lending is permitted, on the basis of a quantity of interference given to a protection area of the first communication device,
the effective service area is a part of the protection area, and
a quantity of interference given by the radio wave transmitted from the second communication device is set to zero for a first area excluding the effective service area of the first communication device in the protection area of the first communication device.

### [Item 6]

The information processing device according to item 5, in which
the protection area of the first communication device is determined on the basis of maximum transmission power of the first communication device.

### [Item 7]

The information processing device according to item 5 or 6, in which
the processing unit transmits the information of the effective service area of the first communication device to a communication control device that determines allowable transmission power of another communication device on the basis of a quantity of interference given to the protection area or the effective service area of the first communication device.

### [Item 8]

The information processing device according to any one of items 1 to 7, in which
the processing unit limits transmission power of the second communication device as a condition for permitting the second operator to lend the right.

### [Item 9]

The information processing device according to item 8, in which
the processing unit determines a maximum value of transmission power of the second communication device in accordance with a position of the second communication device.

### [Item 10]

The information processing device according to any one of items 1 to 9, in which
the processing unit treats the effective service area of the first communication device as a protection area of the first communication device, and determines allowable transmission power of a radio wave transmitted from the second communication device for which the lending is permitted, on the basis of a quantity of interference given to the protection area of the first communication device by the radio wave transmitted from the second communication device.

### [Item 11]

The information processing device according to any one of items 1 to 10, in which
in a case where a protection area of the first communication device overlaps with the desired rental area, the processing unit sets an area obtained by excluding a second area overlapping with the desired rental area from the protection area as a new protection area of the first communication device, and
the processing unit determines allowable transmission power of a radio wave transmitted from the second communication device for which the lending is permitted, on the basis of a quantity of interference given to the new protection area of the first communication device by the radio wave transmitted from the second communication device.

### [Item 12]

The information processing device according to any one of items 1 to 11, in which
the information of the desired rental area includes, as an installation position of the second communication device, a position in a first area obtained by excluding the effective service area from a protection area of the first communication device, and
the processing unit permits lending of the right
in a case where an installation position of the first communication device is outdoors and the installation position of the second communication device is indoors,
in a case where the installation position of the first communication device is indoors and the installation position of the second communication device is outdoors, or
in a case where the installation positions of the first communication device and the second communication device are respectively in buildings different from each other.

### [Item 13]

The information processing device according to any one of items 1 to 12, in which
the processing unit determines allowable transmission power of a radio wave transmitted from the second communication device for which the lending is permitted, on the basis of a quantity of interference given to a protection area or the effective service area of the first communication device by the radio wave transmitted from the second communication device, and
in a case where an installation position of the first communication device is outdoors and an installation position of the second communication device is indoors,
in a case where the installation position of the first communication device is indoors and the installation position of the second communication device is outdoors, or
in a case where the installation positions of the first communication device and the second communication device are respectively in buildings different from each other,
the processing unit
assumes the quantity of interference given to the protection area or the effective service area of the first communication device by the radio wave transmitted from the second communication device as zero, or calculates the quantity of interference by giving an additional loss to the radio wave.

### [Item 14]

The information processing device according to any one of items 1 to 13, in which
in a case where the first communication device is installed in outdoors, the processing unit specifies an outdoor service area which is an effective service area for a terminal present in the outdoors within a coverage of the first communication device and an indoor service area which is an effective service area for a terminal present indoors within the coverage,
the information of the desired rental area includes a position in a third area inside the outdoor service area and outside the indoor service area as an installation position of the second communication device, and
the processing unit permits the lending in a case where the installation position of the second communication device is indoors.

### [Item 15]

The information processing device according to any one of items 1 to 14, in which
the processing unit determines allowable transmission power of a radio wave transmitted from the second communication device for which the lending is permitted, on the basis of a quantity of interference given to an indoor service area of the first communication device and a third area by the radio wave transmitted from the second communication device,
the indoor service area is an effective service area for a terminal present indoors within a coverage of the first communication device in a case where the first communication device is installed in outdoors, and the third area is an area inside an outdoor service area which is an effective service area for a terminal present in the outdoors in the coverage of the first communication device and outside the indoor service area, and
the processing unit assumes a quantity of interference given to the third area by the radio wave transmitted from the second communication device as zero, or calculates a quantity of interference given to the third area by the radio wave transmitted from the second communication device by giving an additional loss to the radio wave.

### [Item 16]

The information processing device according to any one of items 1 to 15, in which
the processing unit receives a lending application for the right including the information of the desired rental area from a device of the second operator, acquires the information of the effective service area of the first communication device on the basis of the lending application, and determines availability of lending of the right to the second operator.

### [Item 17]

A communication device operated by an operator, the communication device including:
a processing unit that
transmits a lending application for a right to preferentially use a radio wave in a desired rental area where the operator desires to operate the communication device,
receives response information including availability of lending of the right determined on the basis of information of an effective service area of a first communication device operated by a first operator who holds the right and information of the desired rental area, and
transmits a request for a registration procedure for using a radio wave in the desired rental area on the basis of the response information.

### [Item 18]

An information processing method including:
acquiring information of an effective service area of a first communication device operated by a first operator that has a right to preferentially use a radio wave, on the basis of allowable transmission power of the radio wave transmitted from the first communication device; and
determining availability of lending of the right to a second operator that operates a second communication device, on the basis of the information of the effective service area of the first communication device and information of a desired rental area where the second operator desires to operate the second communication device.

### [Item 19]

A communication method including:
transmitting a lending application for a right to preferentially use a radio wave in a desired rental area where an operator desires to operate a communication device;
receiving response information including availability of lending of the right determined on the basis of information of an effective service area of a first communication device operated by a first operator who holds the right and information of the desired rental area; and
transmitting a request for a registration procedure for using a radio wave in the desired rental area on the basis of the response information.

### REFERENCE SIGNS LIST

11 Receiving unit
12 Processing unit
13 Control unit
14 Transmitting unit
15 Storage unit
31 Receiving unit
32 Processing unit
33 Control unit
34 Transmitting unit
35 Storage unit
110, 110A, 110B, 110C Communication device
120 Terminal
130, 130A, 130B Communication control device
140 Leasing Manager
150 Device of Lessee

1. An information processing device comprising:
a processing unit that acquires information of an effective service area of a first communication device operated by a first operator that has a right to preferentially use a radio wave, on a basis of allowable transmission power of the radio wave transmitted from the first communication device, and
determines availability of lending of the right to a second operator that operates a second communication device, on a basis of the information of the effective service area of the first communication device and information of a desired rental area where the second operator desires to operate the second communication device.

2. The information processing device according to claim 1, wherein
the processing unit permits lending of the right in a case where the desired rental area does not overlap with the service area of the first communication device.

3. The information processing device according to claim 1, wherein
in a case where an installation position of the second communication device is outside the effective service area of the first communication device and included in a protection area of the first communication device, the processing unit permits lending of the right.

4. The information processing device according to claim 1, wherein
the processing unit calculates the allowable transmission power of the radio wave transmitted from the first communication device for each of a plurality of protection targets, and calculates the effective service area of the first communication device on a basis of a minimum value of the allowable transmission power calculated for each of the plurality of protection targets.

5. The information processing device according to claim 1, wherein
the processing unit determines allowable transmission power of a radio wave transmitted from the second communication device for which the lending is permitted, on a basis of a quantity of interference given to a protection area of the first communication device,
the effective service area is a part of the protection area, and
a quantity of interference given by the radio wave transmitted from the second communication device is set to zero for a first area excluding the effective service area of the first communication device in the protection area of the first communication device.

6. The information processing device according to claim 5, wherein
the protection area of the first communication device is determined on a basis of maximum transmission power of the first communication device.

7. The information processing device according to claim 5, wherein
the processing unit transmits the information of the effective service area of the first communication device to a communication control device that determines allowable transmission power of another communication device on a basis of a quantity of interference given to the protection area or the effective service area of the first communication device.

8. The information processing device according to claim 1, wherein
the processing unit limits transmission power of the second communication device as a condition for permitting the second operator to lend the right.

9. The information processing device according to claim 8, wherein
the processing unit determines a maximum value of transmission power of the second communication device in accordance with a position of the second communication device.

10. The information processing device according to claim 1, wherein
the processing unit treats the effective service area of the first communication device as a protection area of the first communication device, and determines allowable transmission power of a radio wave transmitted from the second communication device for which the lending is permitted, on a basis of a quantity of interference given to the protection area of the first communication device by the radio wave transmitted from the second communication device.

11. The information processing device according to claim 1, wherein
in a case where a protection area of the first communication device overlaps with the desired rental area, the processing unit sets an area obtained by excluding a second area overlapping with the desired rental area from the protection area as a new protection area of the first communication device, and
the processing unit determines allowable transmission power of a radio wave transmitted from the second communication device for which the lending is permitted, on a basis of a quantity of interference given to the new protection area of the first communication device by the radio wave transmitted from the second communication device.

12. The information processing device according to claim 1, wherein
the information of the desired rental area includes, as an installation position of the second communication device, a position in a first area obtained by excluding the effective service area from a protection area of the first communication device, and
the processing unit permits lending of the right
in a case where an installation position of the first communication device is outdoors and the installation position of the second communication device is indoors,
in a case where the installation position of the first communication device is indoors and the installation position of the second communication device is outdoors, or
in a case where the installation positions of the first communication device and the second communication device are respectively in buildings different from each other.

13. The information processing device according to claim 1, wherein
the processing unit determines allowable transmission power of a radio wave transmitted from the second communication device for which the lending is permitted, on a basis of a quantity of interference given to a protection area or the effective service area of the first communication device by the radio wave transmitted from the second communication device, and
in a case where an installation position of the first communication device is outdoors and an installation position of the second communication device is indoors,
in a case where the installation position of the first communication device is indoors and the installation position of the second communication device is outdoors, or
in a case where the installation positions of the first communication device and the second communication device are respectively in buildings different from each other,
the processing unit
assumes the quantity of interference given to the protection area or the effective service area of the first communication device by the radio wave transmitted from the second communication device as zero, or calculates the quantity of interference by giving an additional loss to the radio wave.

14. The information processing device according to claim 1, wherein
in a case where the first communication device is installed in outdoors, the processing unit specifies an outdoor service area which is an effective service area for a terminal present in the outdoors within a coverage of the first communication device and an indoor service area which is an effective service area for a terminal present indoors within the coverage,
the information of the desired rental area includes a position in a third area inside the outdoor service area and outside the indoor service area as an installation position of the second communication device, and
the processing unit permits the lending in a case where the installation position of the second communication device is indoors.

15. The information processing device according to claim 1, wherein
the processing unit determines allowable transmission power of a radio wave transmitted from the second communication device for which the lending is permitted, on a basis of a quantity of interference given to an indoor service area of the first communication device and a third area by the radio wave transmitted from the second communication device,
the indoor service area is an effective service area for a terminal present indoors within a coverage of the first communication device in a case where the first communication device is installed in outdoors, and the third area is an area inside an outdoor service area which is an effective service area for a terminal present in the outdoors in the coverage of the first communication device and outside the indoor service area, and
the processing unit assumes a quantity of interference given to the third area by the radio wave transmitted from the second communication device as zero, or calculates a quantity of interference given to the third area by the radio wave transmitted from the second communication device by giving an additional loss to the radio wave.

16. The information processing device according to claim 1, wherein
the processing unit receives a lending application for the right including the information of the desired rental area from a device of the second operator, acquires the information of the effective service area of the first communication device on a basis of the lending application, and determines availability of lending of the right to the second operator.

17. A communication device operated by an operator, the communication device comprising:
a processing unit that
transmits a lending application for a right to preferentially use a radio wave in a desired rental area where the operator desires to operate the communication device,
receives response information including availability of lending of the right determined on a basis of information of an effective service area of a first communication device operated by a first operator who holds the right and information of the desired rental area, and
transmits a request for a registration procedure for using a radio wave in the desired rental area on a basis of the response information.

18. An information processing method comprising:
acquiring information of an effective service area of a first communication device operated by a first operator that has a right to preferentially use a radio wave, on a basis of allowable transmission power of the radio wave transmitted from the first communication device; and
determining availability of lending of the right to a second operator that operates a second communication device, on a basis of the information of the effective service area of the first communication device and information of a desired rental area where the second operator desires to operate the second communication device.

19. A communication method comprising:
transmitting a lending application for a right to preferentially use a radio wave in a desired rental area where an operator desires to operate a communication device;
receiving response information including availability of lending of the right determined on a basis of information of an effective service area of a first communication device operated by a first operator who holds the right and information of the desired rental area; and
transmitting a request for a registration procedure for using a radio wave in the desired rental area on a basis of the response information.
